(19) United States
(12) Patent Application Publication
(10) Pub. No.: US 2026/0289273 A1
(43) Pub. Date: Sep. 24, 2026

(54) SYSTEM

(71) Applicant: SoftBank Group Corp., Tokyo (JP)

(72) Inventor: Harue ISHII, Tokyo (JP)

(73) Assignee: SoftBank Group Corp., Tokyo (JP)

(21) Appl. No.: 19/567,141

(22) Filed: Mar. 15, 2026

(30) Foreign Application Priority Data
Mar. 19, 2025 (JP) 2025-044929

(51) Int. Cl. G06N 3/0475; G06F 40/205

(52) U.S. Cl. CPC G06N 3/0475; G06F 40/205

(57) ABSTRACT

A system includes a processor that is configured to: provide an interface for inputting life information of a user; automatically collect information from a device of the user through sensors and applications; and generate a prompt for instructing a generative AI model to infer a behavior of the user and input data to the generative AI model by using the prompt.

### CROSS-REFERENCE TO RELATED APPLICATION

This application is based on and claims priority under 35 USC 119 from Japanese Patent Application No. 2025-044929 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional life support systems that aim to improve a user's quality of life typically rely on manually configured rules or simple statistical models that are not able to flexibly adapt to diverse and changing user behaviors. Such systems often require the user to provide extensive manual input and configuration, which increases user burden and reduces continuous usage. In addition, conventional systems generally lack an integrated mechanism for automatically acquiring rich contextual information from user devices, preprocessing such information, and effectively utilizing advanced generative AI models to infer user behavior and personalize proposals. As a result, it is difficult to generate accurate and context-aware life improvement measures that are timely, customized, and robust against noisy or incomplete data. Accordingly, there is a need for a system that can automatically collect user life information, generate appropriate prompts for a generative AI model to infer user behavior, analyze outputs of the generative AI model, and store and preprocess user life information to create a clean dataset, thereby enabling highly personalized and effective life improvement proposals with minimal user burden.

### SUMMARY

In order to solve the above-described problems, an aspect of the present invention provides a system comprising a processor, wherein the processor is configured to provide an interface for inputting life information of a user, automatically collect information from a device of the user through sensors and applications, and generate a prompt for instructing a generative AI model to infer a behavior of the user and input data to the generative AI model by using the prompt. The processor is further configured to analyze an output of the generative AI model and customize proposal content in order to provide an optimal life improvement measure based on a behavior pattern of the user. In addition, the processor is configured to store the life information of the user in a database and perform preprocessing on the life information to generate a clean dataset for input to the generative AI model. By integrating these functions, the system can automatically construct suitable prompts from user life information and contextual data, supply clean and structured input data to the generative AI model, interpret and refine the model's outputs, and derive personalized, context-aware life improvement proposals while reducing manual configuration and improving robustness against noise and variations in user behavior.

The term “life information” refers to information related to a user's daily life, including but not limited to schedules, routines, activities, preferences, habits, locations, and contextual states that characterize the user's lifestyle and behavior.

The term “interface for inputting life information of a user” refers to a user interface, such as a graphical user interface or an input screen, that allows the user to manually enter, edit, or confirm life information, including schedules, activities, preferences, and other lifestyle-related data.

The term “device of the user” refers to any electronic device owned, used, or operated by the user, including but not limited to a smartphone, tablet, wearable device, laptop computer, or desktop computer, which is capable of executing applications, collecting sensor data, and communicating with the system.

The term “sensor” refers to a hardware component or module of the device of the user that detects or measures physical or environmental quantities, such as location, motion, acceleration, heart rate, ambient light, or sound level, and outputs corresponding sensor data.

The term “application” refers to software running on the device of the user, including mobile applications, desktop applications, and background services, which can generate, access, or provide data related to the user's behavior, communication, content consumption, or other activities.

The term “generative AI model” refers to an artificial intelligence model, such as a large language model or other generative model, that is capable of generating outputs including text, recommendations, or inferred states based on prompts and input data describing the user's life information and context.

The term “prompt” refers to a structured input, including text or a data representation, that is generated by the processor to instruct the generative AI model to perform a specific task, such as inferring a behavior of the user, and that includes or references relevant user life information or contextual data.

The term “infer a behavior of the user” refers to determining, estimating, or classifying a current, past, or future action or state of the user, such as working, commuting, resting, sleeping, exercising, or engaging in a hobby, based on life information, sensor data, and other contextual inputs.

The term “output of the generative AI model” refers to data generated by the generative AI model in response to a prompt, including but not limited to inferred user behaviors, contextual interpretations, recommended actions, or textual explanations used by the system.

The term “proposal content” refers to information representing one or more proposed actions, recommendations, or guidance items intended to improve the user's life or quality of life, such as suggestions for activities, rest, exercise, focus enhancement, or sleep improvement.

The term “life improvement measure” refers to a specific action, recommendation, or strategy proposed to the user with the aim of improving the user's quality of life, well-being, health, productivity, or overall lifestyle satisfaction.

The term “behavior pattern of the user” refers to a temporal and contextual pattern derived from repeated behaviors of the user, including regularities in daily routines, preferences for certain activities at particular times or locations, and typical responses to past proposals or situations.

The term “database” refers to a structured data storage system, which may be implemented as one or more logical or physical storage units, for storing user life information, contextual data, model inputs and outputs, and related metadata in an organized and retrievable manner.

The term “preprocessing” refers to operations performed on raw or semi-structured data, including cleaning, filtering, normalizing, formatting, aggregating, or transforming the data, in order to produce a structured and reliable dataset suitable for input to the generative AI model.

The term “clean dataset” refers to a dataset obtained after preprocessing, in which noise, inconsistencies, missing values, and irrelevant data have been reduced or resolved, and which is organized in a consistent structure suitable for accurate processing by the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi®, Bluetooth®, and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

First Exemplary Embodiment

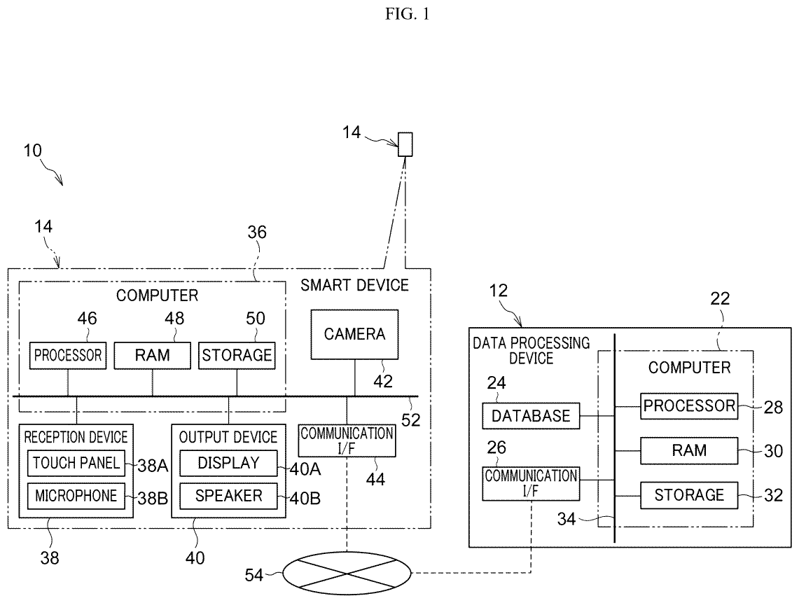

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

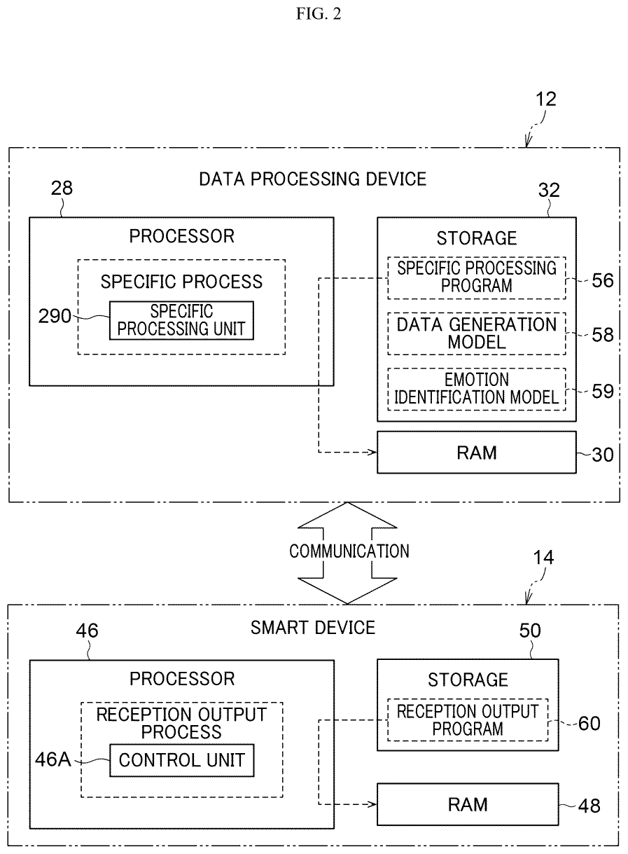

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recommendation systems for lifestyle support typically rely on simple rule-based logic or static models that operate on coarse-grained user profile data. In many implementations, a server merely aggregates discrete events (for example, calendar entries or purchase logs) and applies fixed heuristics to suggest activities or content. Such systems often suffer from several technical limitations.

First, conventional systems do not perform integrated, fine-grained processing of heterogeneous data streams originating from user terminals, such as sensor data, communication logs, and browsing histories, together with explicit life information input by the user. As a result, the server processes fragmented datasets in separate pipelines, leading to incomplete behavior modeling, redundant storage, and inefficient computation. The lack of a unified behavior history representation hinders accurate pattern analysis and degrades the quality and consistency of the generated suggestions.

Second, even when a generative AI model is employed, the interaction between the server and the generative AI model is often naïve. In many systems, the server forwards raw or lightly preprocessed data as a prompt to the model without systematically extracting and encoding behavior feature information. This causes the generative AI model to process noisy, unstructured, or overly verbose input, which increases computational load, reduces inference efficiency, and leads to unstable or irrelevant outputs. Furthermore, these systems generally fail to incorporate structured schedule constraints and user availability into the prompt construction, so that generated suggestions frequently conflict with existing commitments or temporal constraints.

Third, typical systems lack an adaptive feedback mechanism at the server level that uses user responses to dynamically refine the data processing pipeline and the prompt generation strategy. Although user acceptance or rejection of suggestions may be logged, such feedback is rarely transformed into updated feature quantities and behavior profiles that systematically influence future interactions with the generative AI model. Consequently, the server cannot effectively improve the suitability of proposals over time, and the underlying computer processes remain static and suboptimal.

Fourth, existing architectures often treat preprocessing, pattern extraction, prompt construction, and post-processing as loosely coupled modules, which leads to duplicated computations, inconsistent data formats, and difficulties in scaling. There is a need for a server-side design that tightly couples these stages into a coherent, machine-implemented workflow that produces a clean, compressed, and behavior-aware data representation specifically tailored for input to a generative AI model, and that leverages the model output through structured analysis and constraint checking.

Accordingly, there is a need for an improved computer-implemented system and method that: (i) automatically collects and unifies explicit life information and contextual environmental information from user terminals into an integrated behavior history; (ii) computes and maintains behavior feature information and feature quantities that are optimized for use as inputs to a generative AI model; (iii) programmatically constructs structured prompt sentences that encode user behavior patterns, preferences, and future availability; (iv) performs automatic consistency checks between generated activity plans and stored schedule constraints; and (v) closes the loop by updating the behavior feature information and prompt generation logic based on user feedback. Such improvements to the way the server processes, represents, and uses data in conjunction with a generative AI model constitute a technical solution that enhances the functioning of the underlying computer system itself, by reducing noise and redundancy, improving efficiency and relevance of model interactions, and enabling more accurate and adaptive behavior-based proposals.

The specific processing by the specific processing unit 290 of the data processing device 12 in Example 1 is realized by the following means.

The present invention provides a server comprising a processor configured to generate a user interface on an information input-output apparatus for receiving life information including schedule information, preference information, and behavior information from a user; to automatically acquire environmental information including location information, electronic communication records, and browsing history from a user apparatus by using a position detection device, an information acquisition control unit, and a communication unit provided in the user apparatus, and to collect the environmental information in association with the life information; to integrate and store the life information and the environmental information in a storage unit, to perform preprocessing including normalization of time information, aggregation of location information, and classification of behavior types, and thereby to generate integrated data representing a behavior history of the user; to calculate, on the basis of the integrated data, behavior frequencies for each date category, time zone, and place category, repeated behaviors, and preference tendencies, and to generate behavior feature information summarizing the behavior frequencies, the repeated behaviors, and the preference tendencies; to construct, on the basis of the behavior feature information and future available time slot information, a description sentence in a natural language including an operation instruction for a generative AI model, and to generate the description sentence as a prompt sentence for the generative AI model; to generate an electronic communication request for inputting the prompt sentence and the integrated data to the generative AI model, to transmit the electronic communication request to the generative AI model, and to receive a response sentence from the generative AI model; to analyze the response sentence to extract contents of activity plans, including an activity type, a recommended time zone, and a recommended reason, to compare the contents of the activity plans with the schedule information of the user to detect a temporal contradiction or a constraint violation, and to generate a life improvement plan adapted to a behavior pattern of the user by accepting, rejecting, or correcting the activity plans on the basis of a detection result and past acceptance information or rejection information; and to notify the life improvement plan to the information input-output apparatus, to acquire acceptance information or rejection information for the life improvement plan from the information input-output apparatus, and to update the behavior feature information, feature quantities, and contents of generation of the prompt sentence, including a summary content and a description order of the behavior feature information, on the basis of an update history of the feature quantities and the acceptance information or the rejection information. This enables the server to implement an improved, machine-optimized interaction with the generative AI model by providing clean, behavior-aware input data and structured prompt sentences, by enforcing schedule and constraint consistency on generated activity plans, and by adaptively refining internal behavior representations and prompt construction logic according to user feedback, thereby enhancing the accuracy, efficiency, and technical performance of the computer-implemented lifestyle recommendation processes.

The term “information input-output apparatus” refers to an electronic device including, for example, a portable terminal or a stationary computing device, that provides a user interface for inputting information and a display or output mechanism for presenting information to a user.

The term “user apparatus” refers to an electronic device associated with a user, such as a portable communication device or a personal computing device, which includes hardware and software components for sensing, processing, and communicating data related to the user.

The term “life information” refers to information indicating aspects of a user's daily life, including but not limited to schedule information, preference information, and behavior information that describe planned or actual activities of the user.

The term “schedule information” refers to time-related information describing planned activities or events of a user, including dates, times, durations, and recurrence patterns for such activities or events.

The term “preference information” refers to information indicative of a user's likes, dislikes, priorities, or tendencies regarding activities, places, or content, which can be used to determine suitability of proposed actions for the user.

The term “behavior information” refers to information representing actions or activities performed or intended to be performed by a user, including activity types, contexts, and associated descriptive data.

The term “environmental information” refers to contextual data acquired from a user apparatus or associated services, including but not limited to location information, electronic communication records, and browsing history, which reflect the circumstances of the user's activities.

The term “location information” refers to information indicating a geographical position of a user apparatus or a user, such as coordinates, place identifiers, or derived place categories, together with corresponding time information.

The term “electronic communication records” refers to data indicating electronic communications related to a user, including, for example, messages, posts, or interaction logs exchanged over communication networks or application services.

The term “browsing history” refers to records indicating access by a user to network resources, such as visited network addresses, domains, or content identifiers, together with corresponding access times.

The term “position detection device” refers to a hardware or software component configured to determine a geographic position of a user apparatus, including, for example, a satellite positioning receiver, a network-based positioning system, or a similar location-sensing mechanism.

The term “information acquisition control unit” refers to a functional component, implemented in hardware, software, or a combination thereof, that controls acquisition of data from sensors, applications, or external services of a user apparatus.

The term “communication unit” refers to a functional component, implemented by communication hardware and software, that transmits and receives data between a user apparatus and an external system via a communication network.

The term “storage unit” refers to a memory device or a combination of memory devices, including non-transitory computer-readable media, configured to store data such as life information, environmental information, integrated data, and behavior-related information.

The term “integrated data” refers to data generated by combining and preprocessing life information and environmental information, the integrated data representing a unified behavior history or profile of a user in a consistent format.

The term “behavior history” refers to a chronological representation of a user's activities and related contexts, derived from life information and environmental information collected over time.

The term “preprocessing” refers to a series of data processing operations, performed before input to a generative AI model, including but not limited to normalization of time information, aggregation of location information, and classification of behavior types.

The term “normalization of time information” refers to processing that converts various time representations into a standardized temporal format or reference, enabling consistent comparison and analysis of time-related data.

The term “aggregation of location information” refers to processing that groups or consolidates multiple pieces of location-related data into higher-level location categories or representative places, such as home, workplace, gym, or similar place labels.

The term “classification of behavior types” refers to processing that assigns activity data to one or more predefined or learned categories of behavior, such as exercise, work, leisure, or rest.

The term “behavior frequencies” refers to numerical values indicating how often particular behaviors or activity types occur within specified categories, such as date categories, time zones, or place categories.

The term “repeated behaviors” refers to behaviors or activity patterns that recur over time according to a detectable frequency or regularity, such as activities performed on specific days of a week or at certain times of day.

The term “preference tendencies” refers to inferred or calculated indications of a user's relative favorability toward particular behaviors, places, or time periods, derived from observed frequencies, selections, or feedback.

The term “behavior feature information” refers to summary data derived from integrated data, including behavior frequencies, repeated behaviors, and preference tendencies, and used to characterize a user's behavior pattern.

The term “feature quantities” refers to numerical or categorical indicators calculated from life information and environmental information, such as frequencies, tendencies, or scores, which are used to represent characteristics of user behavior in a form suitable for machine processing.

The term “date category” refers to a classification of calendar dates into categories, such as specific days of the week, weekdays versus weekends, or other date-based groupings used for analysis.

The term “time zone” refers to a division of a day into one or more time segments or intervals, such as morning, afternoon, evening, or specific hour ranges, used to categorize when behaviors occur.

The term “place category” refers to a classification of physical locations into abstract place types, such as residence, workplace, exercise facility, or leisure facility, used for analyzing behavior at different kinds of places.

The term “future available time slot information” refers to data indicating time intervals in a future period during which a user is predicted or determined to be free from existing scheduled activities or constraints.

The term “generative AI model” refers to a machine learning model, such as a neural network-based language model, configured to generate output data, including natural language text, in response to input data and an associated prompt.

The term “prompt sentence” refers to a natural language description or instruction constructed by the server, including behavior feature information and operation instructions, which is provided as input to a generative AI model to guide its generation of output.

The term “operation instruction for a generative AI model” refers to a directive included in a prompt sentence that specifies a task or output format to be performed or produced by the generative AI model.

The term “electronic communication request” refers to a formatted data transmission, such as a network request, used to send the prompt sentence and associated data to a generative AI model and to receive a response therefrom.

The term “response sentence” refers to a natural language output generated by the generative AI model in response to the prompt sentence and integrated data provided by the server.

The term “activity plan” refers to a proposed activity or set of activities for a user, including an activity type, an associated time zone, and optionally a reason or explanation, which is derived from the response sentence.

The term “life improvement plan” refers to a structured set of one or more activity plans that has been accepted, filtered, or corrected by the server to conform to a user's schedule, constraints, and behavior pattern.

The term “temporal contradiction” refers to a conflict between a proposed time in an activity plan and existing schedule information, such as overlapping or impossible time intervals.

The term “constraint violation” refers to a situation in which a proposed activity plan does not satisfy predefined conditions, such as user-specified limitations, resource availability constraints, or system-defined rules.

The term “acceptance information” refers to information indicating that a user has approved or chosen to follow a proposed life improvement plan or an individual activity plan.

The term “rejection information” refers to information indicating that a user has declined or chosen not to follow a proposed life improvement plan or an individual activity plan.

The term “update history of the feature quantities” refers to records indicating successive changes or time-based evolution of feature quantities that represent user behavior and preferences.

The term “summary content of the behavior feature information” refers to condensed descriptive information extracted from behavior feature information, which is included in a prompt sentence to describe key aspects of a user's behavior.

The term “description order of the behavior feature information” refers to a sequence in which elements of the behavior feature information are presented within a prompt sentence, which may be adjusted based on the update history of feature quantities or user feedback.

In one embodiment, a server executes a life-information management program stored in a non-transitory computer-readable medium. The server includes at least one processor, a main memory, a persistent storage device, and a network interface. The server operates under control of an operating system such as a general-purpose server operating system, and executes application software implemented, for example, using a web application framework. The server communicates with one or more terminals via a communication network such as the Internet.

A terminal includes, for example, a portable communication device or a personal computing device equipped with a display, an input interface, a position detection device, a communication unit, and local storage. The terminal executes an application that presents user interfaces for entering life information and for viewing generated life improvement plans. The terminal application may be implemented as a native mobile application or as a web application executed by a browser.

A user operates the terminal to provide explicit life information. The user inputs schedule information, preference information, and behavior information through graphical user interface components such as text fields, selection lists, and calendar widgets displayed on the terminal. The terminal transmits the input life information to the server via the network interface using a communication protocol such as HTTPS.

The server configures the life-information management program to define data structures and databases for storing life information and environmental information. The server defines, for instance, a user table, an events table, an environmental logs table, a behavior features table, and a proposals table in a relational database management system. The server stores timestamps in a normalized format, identifies users by unique identifiers, and records references between explicit life information and automatically acquired environmental information.

The terminal acquires environmental information automatically from device hardware and software components. The terminal uses the position detection device to obtain location information represented by latitude and longitude coordinates with associated timestamps. The terminal uses an information acquisition control unit implemented as a software module to collect electronic communication records and browsing history from applications and system logs, subject to user permissions. The terminal pre-processes raw sensor readings to remove duplicates and to group nearby location samples into stays. The terminal then transmits the environmental information to the server in structured form.

The server associates environmental information with life information by using temporal correlation and user identifiers. The server determines, for example, that a set of location samples occurring within a threshold time window of a scheduled gym event corresponds to a gym activity, and labels that cluster accordingly. The server aggregates location information by applying clustering methods to identify frequently visited locations and assigns place categories such as residence, workplace, exercise facility, or leisure facility. By representing environmental information and life information in unified data structures, the server constructs integrated data that encodes a behavior history of the user.

The server performs preprocessing computations on the integrated data to normalize and compress information for subsequent use. The server normalizes time information by converting all timestamps to a reference time zone and by mapping them into discrete time zone categories, such as morning, afternoon, evening, and night, as well as hourly bins. The server aggregates location information by mapping coordinate clusters to place categories and by counting visits per place category. The server classifies behavior types by applying rule-based mappings and supervised learning models that convert text descriptions and contextual signals into behavior labels, such as exercise, work, commuting, leisure, or rest.

The server computes feature quantities that characterize user behavior in a form suitable for machine processing. The server calculates behavior frequencies per time zone category, stay tendencies per place category, and preference degrees per behavior type. The server stores these feature quantities in the behavior features table as vectors or structured records, and maintains an update history of these feature quantities over time. By using these feature quantities instead of raw event logs, the server reduces data dimensionality and noise before interacting with a generative AI model.

The server configures the generative AI model as a neural network-based language model. In one embodiment, the generative AI model is a transformer-based model including an input embedding layer, multiple attention-based hidden layers, and an output projection layer that produces token probabilities. The generative AI model is trained on large amounts of text data and fine-tuned on task-specific data that include activity descriptions and lifestyle suggestions.

The model parameters are adjusted during training by minimizing a loss function such as cross-entropy between predicted token distributions and ground-truth tokens, using an optimization method such as stochastic gradient descent with adaptive learning rates. The generative AI model applies self-attention mechanisms to capture long-range dependencies in the prompt sentence and to generate coherent response sentences.

The server configures the life-information management program to construct a prompt sentence for the generative AI model. The server assembles a natural language description that includes behavior feature information, such as typical activities in different time zones, place categories with high visit frequencies, and inferred preference tendencies. The server also appends future available time slot information derived from analyzing the events table, where the server computes free intervals by subtracting scheduled events from a pre-defined daily activity window. The server includes an operation instruction for the generative AI model that specifies the required output format and constraints, such as the number of activity plans, inclusion of time ranges, and provision of reasons tailored to the user's behavior.

In one example, the server generates the following prompt sentence:
“Analyze the following user behavior data and propose specific weekend activities.
Behavior summary: On weekdays, the user goes to an exercise facility about three times in the evening and runs every Tuesday at 19:00. On weekend afternoons, the user often visits leisure facilities and enjoys reading quietly. The user prefers light outdoor exercise and relaxing activities.
Upcoming schedule: This Saturday and Sunday, the user is free between 10:00 and 18:00.
Task: As a generative AI model, generate three realistic, feasible, and concrete activity plans for this weekend. For each plan, include: (1) activity name, (2) approximate time range, and (3) a short reason tailored to the user's preferences.”

In another example, the server generates the following prompt sentence:
“Based on this user's weekly behavior: visits to an exercise facility on three evenings per week, running every Tuesday at 19:00, frequent visits to leisure facilities on weekend afternoons, and a preference for quiet reading, generate a 7-day exercise and relaxation plan. For each day, propose one main activity, an approximate time, and a brief reason.”

The server transmits the prompt sentence and selected feature quantities to the generative AI model through a network request. The server may use an application programming interface client within the life-information management program to encode the prompt sentence as a sequence of tokens and to send these tokens to a remote model execution environment or to a locally hosted model instance. The generative AI model processes the prompt sentence using the configured neural network layers and generates a response sentence token by token according to learned probability distributions.

The server receives the response sentence from the generative AI model and parses it to extract activity plans. The server identifies text segments that correspond to activity names, time ranges, and reasons by using delimiter patterns or by applying secondary parsing models. The server then compares the proposed time ranges with existing schedule information stored in the events table to detect temporal contradictions such as overlaps with fixed appointments or periods marked as unavailable. The server further checks for constraint violations, for example, by applying rule-based checks against user-defined preferences (such as avoiding late-night activities) or system constraints (such as travel time between locations).

The server corrects or filters activity plans based on detection results. When the server detects conflicts, the server may shift time ranges to the nearest available interval or drop particular plans. The server may also recompute suitability scores for each activity plan by combining behavior frequencies from the behavior features table and past acceptance or rejection information stored in a feedback table. By ranking activity plans according to these suitability scores, the server produces a life improvement plan that is both behavior-aware and constraint-consistent.

The server transmits the life improvement plan to the terminal, for example as a list of items each including an activity name, a proposed time range, and a reason. The terminal displays the life improvement plan on the screen, allowing the user to review each activity plan and to provide feedback. The user selects acceptance or rejection for each plan, and may optionally adjust details such as time ranges. The terminal sends acceptance information and rejection information back to the server.

The server updates the feature quantities and behavior feature information on the basis of the feedback. When activity types or time zones are repeatedly accepted, the server increases corresponding feature quantities, and when they are frequently rejected, the server decreases them. The server records this update history and uses it when constructing future prompt sentences. For example, the server changes the description order of behavior feature information in the prompt sentence to emphasize frequently accepted activities earlier, and to de-emphasize rejected activities. By changing the content and order of the prompt sentence, the server causes the generative AI model to condition its internal attention mechanisms differently, which results in a higher probability of generating suitable activity plans.

The server thus implements a closed-loop process that improves computer performance over time. By transforming high-volume, heterogeneous raw data into compact feature quantities and by presenting these feature quantities within controlled prompt sentences, the server reduces the amount of irrelevant information processed by the generative AI model, which can reduce computational load and latency. By using precomputed, behavior-specific feature quantities, the server prevents repeated processing of the same raw data for each request, thereby improving processing speed. Moreover, by systematically filtering and correcting generated activity plans according to schedule and constraint checks performed by specific algorithms, the server reduces errors and improves the reliability of the outputs.

The server achieves a technical improvement over conventional systems that merely aggregate data and call a model with free-form prompts. In the described embodiment, the server implements specific data structures (feature vectors and behavior profiles), specific preprocessing steps (time normalization, location aggregation, and behavior classification), and specific prompt construction rules that encode schedule constraints and behavior features. These steps are not direct automation of human mental tasks, because a human user would not practically compute and maintain multi-dimensional feature quantities or dynamically manipulate the internal conditioning of a large language model. Instead, the server executes algorithmic procedures that reorganize and compress data in ways tailored to the architecture of the generative AI model, thereby improving the interaction between the server and the model.

The server can employ different variants of the generative AI model in alternative embodiments. In one embodiment, the generative AI model operates as a sequence-to-sequence transformer with encoder and decoder components. In another embodiment, the generative AI model uses a decoder-only transformer architecture. In each case, the server adapts tokenization methods, context window sizes, and temperature or sampling parameters to match the model. The server may also employ additional training or fine-tuning methods, such as supervised fine-tuning on user-specific interaction histories, or reinforcement learning with feedback signals derived from acceptance information and rejection information. By incorporating such training information, the generative AI model can reduce its prediction error on activity suggestion tasks, which in turn reduces the number of corrections required by the server.

The server can further implement alternative algorithms for computing behavior frequencies and feature quantities. In one embodiment, the server uses batch processing to recompute all feature quantities periodically, while in another embodiment the server uses an incremental update method that adjusts feature quantities in response to each new event or feedback record. The incremental method reduces computation time and allows the server to operate on lower hardware resources while still maintaining up-to-date behavior feature information.

The terminal may vary in implementation without departing from the scope of the invention. In one embodiment, the terminal is a smartphone using a native operating system, and the life-information management functions are provided by a dedicated application. In another embodiment, the terminal is a desktop computer executing a browser that accesses the server's web-based interfaces. In both cases, the terminal collects environmental information via device-specific APIs and presents the server-generated life improvement plans in user-friendly layouts. Because the server performs most of the heavy processing, the terminals can be relatively lightweight in computational capability, which broadens the applicability of the system.

The user may interact with the system in different usage scenarios. In one scenario, the user focuses on optimizing exercise and relaxation schedules, and the server emphasizes exercise-related behavior types in computing feature quantities and constructing prompt sentences. In another scenario, the user focuses on social activities or learning goals, and the server adjusts behavior classification and prompt construction rules accordingly. By reusing the same underlying feature quantity computation and generative AI model architecture, the server supports multiple application domains without redesigning the core processing pipeline.

By employing the above-described structures and operations, the server, the terminal, and the user cooperate to implement a lifestyle recommendation system that is technically grounded in specific data processing algorithms, model interaction procedures, and feedback-driven adaptations. The system improves the efficiency, accuracy, and scalability of computer-implemented lifestyle support, and demonstrates a technical effect in terms of reduced computational overhead for the generative AI model, improved data management through feature-based representations, and enhanced precision of generated activity plans through constraint checking and feedback-based refinement.

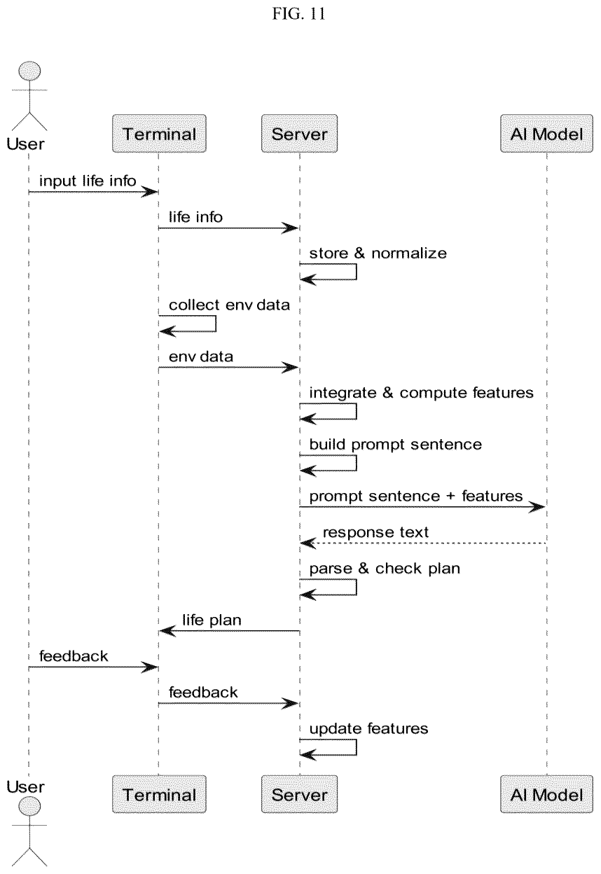

The following describes the processing flow using FIG. 11.

### Step 1

User operates the terminal to input life information.

User enters schedule information, preference information, and behavior information through input fields, check boxes, and calendar widgets displayed on the terminal. The input includes, for example, text such as “I run every Tuesday at 19:00” and “I visit a cafe on Saturday afternoon,” and selections of preferred activity types such as exercise, reading, or outdoor activities.

Terminal receives this input as raw text and structured selections. Terminal converts the input into a structured internal format, for example, a record containing a user identifier, date, time, activity label, recurrence pattern, and optional free-text description. As an output, the terminal generates structured life information data and transmits it to the server via a secure communication channel.

### Step 2

Server receives the life information and stores it in a database.

Server takes as input the structured life information data transmitted from the terminal. Server validates each field, for example, by checking that date and time strings can be parsed into valid timestamps and that activity labels match predefined categories. Server converts the validated data into database records by mapping user identifiers, timestamps, and activity descriptions to corresponding columns in tables such as a user table and an events table.

Server performs data processing that includes normalizing timestamps to a reference time zone, resolving recurrence expressions (such as “every Tuesday”) into recurrence rules, and converting textual activity descriptions into normalized labels using a rule-based mapping or a lightweight classification model. As an output, the server produces persistent event records stored in the database, constituting a part of the user's life information.

### Step 3

Terminal automatically acquires environmental information from device hardware and software.

Terminal uses the position detection device to read current latitude and longitude values along with timestamps at periodic intervals or upon significant movement. Terminal also uses an information acquisition control unit to read electronic communication records such as short messages or social posts, and browsing history such as visited domains and access times, from device logs or application interfaces. The input to this step is the raw sensor readings and application logs present on the terminal.

Terminal processes these inputs by filtering out duplicate or low-confidence readings, grouping consecutive location points into stays when positions remain within a distance threshold for longer than a time threshold, and extracting relevant keywords from communication records that indicate activities (for example, “workout,” “hike,” “reading”). As an output, the terminal generates structured environmental information records that include summarized location stays, communication snippets, and browsing entries, and transmits these records to the server.

### Step 4

Server integrates life information and environmental information into integrated data.

Server takes as input the persistent event records from Step 2 and the environmental information records from Step 3. Server performs temporal and spatial correlation by aligning environmental records with scheduled or observed events using time windows and location proximity criteria. For example, server matches a location stay near an exercise facility between 18:50 and 20:10 with a scheduled exercise event at 19:00, and labels the combined record as an exercise activity.

Server executes data processing that includes joining tables based on user identifiers, applying clustering algorithms on location coordinates to derive place categories, and resolving conflicts when multiple environmental records overlap. Server then converts the combined results into integrated data objects that represent chronological sequences of user activities with associated context (time zone, place category, and environmental signals). As an output, the server stores integrated data representing the user's behavior history in a dedicated storage structure.

### Step 5

Server computes behavior feature quantities and behavior feature information.

Server uses the integrated data from Step 4 as input. Server iterates over the behavior history and counts occurrences of activity types per date category (such as weekday or weekend), time zone (such as morning or evening), and place category (such as residence or exercise facility). Server computes numerical feature quantities such as visit frequency per place category, average start times of recurring events, and relative preference scores for behavior types based on occurrence counts and user choices.

Server aggregates these feature quantities into behavior feature information, which is a compact summary of user behavior patterns. Server, for example, converts raw counts into normalized frequencies and ranks activity types by their preference scores. As an output, the server stores behavior feature vectors or structured records in a behavior features table and prepares them for prompt construction.

### Step 6

Server determines future available time slot information.

Server takes as input the events stored in the events table and a predefined daily activity window for the user, such as 07:00 to 23:00. Server computes the set of occupied intervals by reading all scheduled events in a target period, such as the next seven days or the upcoming weekend. Server then subtracts these occupied intervals from the daily activity window to obtain free time blocks where no events are scheduled.

Server performs data processing that includes sorting events by start time, merging overlapping intervals, and iteratively scanning the day to identify gaps larger than a minimum duration threshold. As an output, the server generates a list of available time slots including start times, end times, and dates, which it stores or maintains in memory for use in prompt construction.

### Step 7

Server constructs a prompt sentence for the generative AI model.

Server uses as input the behavior feature information from Step 5 and the available time slots from Step 6. Server formats a natural language description that summarizes typical user behaviors, such as “The user goes to an exercise facility three evenings per week” and “The user frequently visits leisure facilities on weekend afternoons and reads quietly.” Server then appends statements describing the available time slots, such as “This Saturday and Sunday, the user is free between 10:00 and 18:00.”

Server incorporates an operation instruction that specifies the required task and output format, for example, requesting a specific number of activity plans, each with an activity name, time range, and reason. Server concatenates these elements into a coherent prompt sentence. As an output, the server generates a complete prompt sentence string and prepares an accompanying set of feature quantities that will be provided to the generative AI model.

### Step 8

Server sends the prompt sentence and feature quantities to the generative AI model and receives a response sentence.

Server takes as input the prompt sentence and selected feature quantities representing the user's behavior. Server tokenizes the prompt sentence into tokens according to the vocabulary of the generative AI model and may embed feature quantities as additional tokens or metadata. Server then transmits these inputs to the generative AI model via a communication interface, specifying model parameters such as temperature, maximum output length, and decoding strategy.

Generative AI model processes the tokenized prompt sentence through its neural network layers and generates a sequence of output tokens representing a response sentence that includes proposed activity plans. Server receives this sequence and converts it back into readable text. As an output, the server obtains a response sentence containing multiple activity suggestions with associated time ranges and reasons.

### Step 9

Server parses the response sentence and detects temporal contradictions and constraint violations.

Server uses the response sentence from Step 8 as input. Server applies parsing rules or a secondary parsing module to identify segments corresponding to activity names, recommended time zones or specific times, and reasons. Server converts identified time expressions into machine-readable time intervals and associates each interval with a proposed activity.

Server then compares these intervals with the user's existing schedule from the events table and with constraint data such as user-configured forbidden times or place limitations. Server executes interval overlap checks and rule evaluations to detect temporal contradictions (for example, overlapping with an existing appointment) and constraint violations (for example, suggesting a late-night activity when the user prefers not to be active after a specified hour). As an output, the server produces a list of preliminary activity plans, each annotated with flags indicating whether conflicts or violations were detected.

### Step 10

Server generates a life improvement plan adapted to the user's behavior pattern.

Server takes as input the annotated activity plans from Step 9 and the behavior feature information and feedback records. Server calculates a suitability score for each activity plan by combining behavior frequencies, preference degrees, and penalty terms for any conflicts or prior rejections of similar activities. Server may discard plans whose suitability score falls below a threshold and adjust time ranges for plans with minor conflicts by shifting them to adjacent available slots.

Server selects the most suitable activity plans and organizes them into a life improvement plan. During this data processing, the server sorts plans by suitability score and formats the selected plans with clear titles, time intervals, and explanatory reasons. As an output, the server produces a finalized life improvement plan that aligns with the user's behavior pattern and existing schedule.

### Step 11

Server transmits the life improvement plan to the terminal.

Server uses the finalized life improvement plan from Step 10 as input. Server converts the plan into a representation suitable for display, including text for activity names, human-readable time ranges, and brief reasons. Server packages this information into a response message and transmits it to the terminal via the network interface.

Terminal receives the response message and extracts the activity plans. Terminal then renders the life improvement plan on the display, for example, as a list with selectable entries. As an output of this step, the terminal shows the user the activity plans generated and refined by the server.

### Step 12

User provides feedback on the life improvement plan, and the terminal sends feedback information to the server.

User reviews the proposed activity plans displayed on the terminal and chooses actions such as accept, decline, or modify for individual plans. User may, for example, accept a proposed hike on Saturday morning, reject an evening activity that conflicts with personal preferences, or adjust a time range to start later in the day.

Terminal takes these user actions as input and converts them into structured feedback information indicating acceptance or rejection, optionally including modifications or comments. Terminal then transmits this feedback information to the server as an output of this step.

### Step 13

Server updates feature quantities, behavior feature information, and future prompt construction based on feedback.

Server receives the feedback information from Step 12 as input. Server updates feature quantities by increasing preference degrees or frequencies for activity types and time zones that are accepted, and by decreasing them for those that are rejected. Server records these updates in the behavior features table along with timestamps to maintain an update history.

Server then adjusts rules and parameters for constructing future prompt sentences. For example, the server modifies weightings used when selecting which behavior features to highlight in the behavior summary section of the prompt and reorders the description so that frequently accepted behaviors appear earlier in the text. By performing these data recalculations and rule adjustments, the server produces updated behavior feature information and updated prompt construction parameters as outputs, which will be used as inputs for the next cycle starting at Step 5 or Step 7.

Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information recommendation systems typically rely on static rule-based engines, coarse user profiles, or simple statistical models to provide content or advertisement information to users. Such systems often treat user data as isolated events and fail to construct a rich, temporally and contextually coherent representation of a user's lifestyle. As a result, these systems are unable to accurately infer a user's current situation or near-future intent, and therefore cannot generate timely and highly relevant proposals that effectively improve the user's quality of life.

From a computer-technology standpoint, existing architectures suffer from several technical shortcomings. First, there is no integrated pipeline in which heterogeneous lifestyle-related data (including schedule information, preference information, behavior information, sensor information, and electronic records obtained from multiple devices and applications) are systematically collected, normalized, preprocessed, and transformed into a machine-consumable data set optimized for input to a generative AI model. This leads to inefficient data handling, increased processing latency, and reduced accuracy of inferred user states.

Second, conventional systems do not exploit generative AI models in a structured and programmable manner. In particular, they lack a mechanism to automatically construct context-rich prompt sentences that encode both the user's current and historical lifestyle context and explicit generation constraints, and to use those prompt sentences in a multi-stage interaction with a generative AI model. Without such a mechanism, the computational resources of the generative AI model are underutilized, and the system cannot reliably derive high-quality estimation information or generate concrete, personalized lifestyle-improvement proposals.

Third, existing recommendation systems generally process external content or advertisement feeds in isolation from generative inference results. They do not employ a unified relevance-scoring and ranking mechanism that combines estimation information obtained from a generative AI model and proposal information derived therefrom with external candidate information. Consequently, these systems are unable to efficiently select, rank, and present external content in a way that is tightly aligned with dynamically inferred user situations, which leads to redundant processing, suboptimal bandwidth usage, and low user engagement.

Fourth, many systems lack a feedback loop that treats user interaction with proposals and external information as additional machine-readable behavior history. Without integrating this feedback into the same data pipeline used for inference and proposal generation, the system cannot continuously refine its internal models or dynamically adjust prompt sentences and proposal content. This limits the system's ability to adapt to changes in user behavior patterns and reduces the technical effectiveness of personalization over time.

Fifth, conventional implementations do not include a systematic control mechanism for assigning validity periods and priorities to generated proposals and external information based on inferred temporal and spatial context. As a result, user devices may display outdated or low-priority information, which degrades the technical efficiency of user interface presentation, wastes communication and rendering resources, and fails to leverage real-time context for optimal information delivery.

Accordingly, there is a need for a computer-implemented system and method that technically improve the way user lifestyle-related information is acquired, preprocessed, and fed into a generative AI model; that programmatically constructs and manages prompt sentences for generative inference and proposal generation; that integrates external content selection and ranking with generative inference results; that incorporates user interaction feedback into a continuous learning loop; and that controls presentation timing and priority on a terminal device based on inferred temporal and spatial context.

The specific processing by the specific processing unit 290 of the data processing device 12 in Application Example 1 is realized by the following means.

The present invention provides a server comprising a processor configured to acquire user lifestyle-related information including schedule information, preference information, and behavior information via an input/output device; automatically collect measurement information, activity history information, and electronic record information from one or more information acquisition devices including at least a position detection device, a motion detection device, and application software; store the collected information in association with the user lifestyle-related information; convert the stored lifestyle-related information into a table-type data structure; generate, by executing numerical calculation processing including missing-value completion processing and outlier-removal processing, a learning data set optimized for input to a generative AI model; generate context information describing a situation and interest of a user based on the lifestyle-related information; construct a first prompt sentence including the context information and generation instruction conditions as an input sentence to the generative AI model; obtain, by causing the generative AI model to process the first prompt sentence, estimation information representing the situation and interest of the user; construct, based on the estimation information, a second prompt sentence for generating proposal information relating to lifestyle improvement; generate, by causing the generative AI model to process the second prompt sentence, a plurality of concrete pieces of proposal information; acquire candidate information including at least one of advertisement information and content information from an external information providing device; select and rank the candidate information based on a degree of relevance to the estimation information and the proposal information; integrate the proposal information and selected external information to generate display-structured information; assign, based on time information and position information included in the estimation information, validity-period information and priority information to at least one of the proposal information and the external information; and transmit the display-structured information together with the validity-period information and the priority information to a terminal device so as to control a presentation order and a presentation mode on the terminal device. This enables a technically improved end-to-end data processing and inference pipeline that efficiently transforms heterogeneous lifestyle-related data into structured inputs for a generative AI model, programmatically generates and refines prompt sentences, produces contextually accurate estimation information and lifestyle-improvement proposals, tightly aligns external content selection and ranking with generative inference results, incorporates user interaction feedback into subsequent processing, and dynamically controls real-time presentation on a user device, thereby enhancing computational efficiency, personalization accuracy, and the overall effectiveness of computer-implemented information provision.

The term “user lifestyle-related information” refers to information associated with a user's daily life, including at least schedule information, preference information, and behavior information, which is obtained through user input and device-based collection and is used to characterize the user's activities and interests over time.

The term “schedule information” refers to information indicating planned or scheduled activities of a user, including times, dates, and descriptions of events, tasks, or appointments.

The term “preference information” refers to information indicating likes, dislikes, priorities, or interests of a user regarding content, activities, goods, or services, which can be explicit (user-provided) or implicit (inferred from behavior).

The term “behavior information” refers to information indicating actual actions or activities performed by a user, including usage patterns of devices or applications, interaction histories, and real-world movements or activities.

The term “input/output device” refers to any hardware and software combination that enables a user to input information into, and receive information from, a computing system, including but not limited to a terminal device, a graphical user interface, a touch screen, a keyboard, a pointing device, a microphone, and a display.

The term “information acquisition device” refers to a device or combination of devices and software modules that automatically obtain measurement information, activity history information, and electronic record information related to a user, and provide such information to a server or processor.

The term “position detection device” refers to any hardware and software component configured to obtain information indicating a geographic location of a user or device, including but not limited to a global positioning system receiver, a wireless communication module, and associated positioning algorithms.

The term “motion detection device” refers to any hardware and software component configured to detect movement or physical activity, including but not limited to an accelerometer, a gyroscope, a magnetometer, and corresponding signal processing modules.

The term “application software” refers to executable software programs running on a computing device, including mobile applications, web applications, and desktop applications, that manage or generate data such as calendar entries, social media posts, content consumption logs, or health-related records.

The term “measurement information” refers to data obtained by sensors or measuring components, including but not limited to location coordinates, movement parameters, environmental conditions, or biometric measurements, associated with a user or device.

The term “activity history information” refers to a chronological record of user activities, including device usage, application usage, physical movement, and content consumption, which can be used to derive behavior patterns.

The term “electronic record information” refers to digital records stored or generated by applications or services, including calendar events, messages, posts, logs, transaction records, and other electronically stored user-related data.

The term “table-type data structure” refers to a structured representation of data organized in rows and columns, such as a table or data frame, where each row represents an instance or event and each column represents an attribute or feature.

The term “numerical calculation processing” refers to processing performed using arithmetic and statistical operations on numeric data, including but not limited to aggregation, normalization, transformation, and statistical estimation.

The term “missing-value completion processing” refers to a procedure for detecting and filling in absent or undefined data values in a data set using predefined rules, default values, or statistical estimation techniques.

The term “outlier-removal processing” refers to a procedure for detecting and handling data points that deviate significantly from expected ranges or distributions, including removal, replacement, or separate marking of such data points.

The term “learning data set” refers to a processed and structured collection of data suitable for input to a machine learning model or generative AI model, used for training, inference, or both.

The term “generative AI model” refers to a machine learning model configured to generate outputs such as text, images, or other data, based on input data or prompt sentences, and including but not limited to large language models and other generative models.

The term “context information” refers to information that describes a current or inferred situation of a user, including but not limited to temporal context, spatial context, historical activity, and user interests, which is used to condition processing by a generative AI model.

The term “generation instruction conditions” refers to constraints or instructions included in a prompt sentence, such as requested output type, style, length, format, or content requirements, that guide the behavior of a generative AI model.

The term “prompt sentence” refers to an input text or structured input provided to a generative AI model, including context information and generation instruction conditions, which instructs the model to perform a particular generation or estimation task.

The term “estimation information” refers to information representing an inferred situation, interest, intent, or behavior of a user, obtained as an output from a generative AI model based on a prompt sentence and input data.

The term “proposal information” refers to information generated for the purpose of providing suggestions, recommendations, or guidance to a user, including concrete lifestyle-improvement proposals, options, or actions.

The term “concrete pieces of proposal information” refers to individually distinguishable units of proposal information, each expressing a specific recommendation or action item, typically in natural language suitable for presentation to a user.

The term “external information providing device” refers to a device, system, or service that supplies candidate information such as advertisements, promotional content, or general content items to the server or processor for selection and presentation.

The term “candidate information” refers to information items provided from an external information providing device, including advertisement information or content information, which are subject to selection and ranking according to user-related criteria.

The term “advertisement information” refers to information describing commercial offerings, promotions, or sponsored content intended to be presented to a user.

The term “content information” refers to non-advertising information items including media content, informational articles, event details, or other informational resources that can be presented to a user.

The term “degree of relevance” refers to a quantitative or qualitative measure indicating how closely a candidate information item is related to the estimation information or the proposal information for a user.

The term “display-structured information” refers to information formatted and organized for presentation on a user interface, including layout, grouping, metadata, and content elements necessary to render proposal information and external information on a terminal device.

The term “terminal device” refers to any user-side computing device capable of communicating with a server and presenting information to a user, including but not limited to a smartphone, tablet, personal computer, or wearable device.

The term “operation history” refers to information indicating user interactions with displayed items on a terminal device, including selections, clicks, taps, scrolls, dismissals, and saves.

The term “behavior history information” refers to a subset of lifestyle-related information consisting of historical records of user operations or actions, particularly interactions with proposal information or external information on a terminal device.

The term “validity-period information” refers to information indicating a temporal range or expiration time during which proposal information or external information is considered valid for presentation to a user.

The term “priority information” refers to information indicating a relative importance or precedence assigned to each piece of proposal information or external information for controlling presentation order or emphasis.

The term “presentation order” refers to a sequence or arrangement in which multiple items of proposal information or external information are displayed on a terminal device.

The term “presentation mode” refers to a manner or style in which information is visually or otherwise presented on a terminal device, including layout, size, prominence, notification style, or interaction mechanisms.

In one embodiment, a server, a terminal, and a user cooperate to implement the claimed system. The server includes at least one processor, a memory, a non-volatile storage device, a network interface, and optionally one or more hardware accelerators. The server runs an operating system such as a general-purpose server operating system and executes application software including a web server, an application server, a database management system, and a generative AI model execution environment. The terminal includes a processor, a memory, a display, an input device such as a touch panel, a communication interface, and various sensors such as a position detection device and a motion detection device. The user operates the terminal to provide lifestyle-related information and to consume proposals and external information generated by the server.

The server executes a program stored in the non-volatile storage device and loaded into the memory. The program is implemented, for example, using a programming language environment such as a general-purpose language and a data analysis stack including a table-processing library and a numerical computation library. In one embodiment, the server uses a table-processing library equivalent to a common data frame library to represent lifestyle-related information as a table-type data structure, and uses a numerical library equivalent to a multi-dimensional array library to perform missing-value completion, outlier detection, and feature transformation. By using these libraries, the server can efficiently perform vectorized numerical operations in memory, which reduces processing latency compared to manual or row-wise processing and thereby improves overall system throughput when handling large volumes of lifestyle-related records.

The server stores user lifestyle-related information in a relational database management system. The database defines tables for user profiles, lifestyle events, sensor measurements, application logs, estimation records, proposal records, and external content items. Each lifestyle event row includes attributes such as user identifier, timestamp, location coordinates, activity type, free-text description, and linked application identifiers. Each sensor measurement row includes attributes such as timestamp, sensor type, raw value array, and derived features. By normalizing these data into relational tables, the server can perform efficient indexed queries to retrieve user-specific historical context and can apply joins and aggregations without loading irrelevant data into memory. This improves data management efficiency, reduces memory usage, and lowers input/output overhead.

The terminal operates an application that provides an input/output device to the user. The terminal displays user interface screens allowing the user to input schedule information, preference information, and behavior information. The user can, for example, type “Watch a movie this weekend” into a schedule input field, select “science fiction” and “action” as preferred genres from a list, and mark an expected time range such as “Saturday evening.” The terminal further acquires measurement information and activity history information automatically. The terminal reads position information from a position detection device, such as a global positioning satellite receiver or a network-based location module, and reads motion-related information, such as step counts or movement patterns, from a motion detection device such as an accelerometer or a gyroscope. The terminal also accesses application software such as a calendar application, a media consumption application, and a social communication application through exposed interfaces or log files to obtain electronic record information.

The terminal aggregates user-entered lifestyle-related information and automatically acquired information into a structured message. The terminal associates each record with metadata including a device identifier, a timestamp, and a coarse-grained location area. The terminal then transmits the structured message to the server over a communication network using a reliable application-layer protocol such as a secure hypertext transfer protocol. By offloading heavy processing to the server while handling initial data capture locally, the terminal can remain resource-efficient and responsive, which is particularly important on battery-powered devices.

The server receives the structured message through a network interface. The server validates the message, performs user authentication, and writes the lifestyle-related records to the relational database. The server then retrieves recent and historical records associated with the same user and loads them into a table-type data structure in memory. Each row of this structure corresponds to a lifestyle event or sensor measurement, and each column corresponds to a feature such as time-of-day, day-of-week, location cluster identifier, activity label, and preference category.

The server uses the numerical computation library to perform missing-value completion processing. For example, when a location field is missing for a lifestyle event, the server infers a likely location cluster based on temporal proximity to other events with known locations. The server applies statistical imputation methods such as median imputation or nearest-neighbor imputation, and encodes the imputed values in the table. The server then performs outlier-removal processing. The server detects outliers by computing z-scores or interquartile range-based thresholds for continuous features such as movement distance per unit time, and by pattern-based detection for categorical features such as improbable transitions in activity labels. For detected outliers, the server either removes the corresponding rows or replaces the anomalous values with capped values. This preprocessing results in a learning data set that is numerically stable and suitable for use with a generative AI model.

The server constructs feature vectors for the generative AI model by concatenating and encoding the preprocessed columns. Temporal features such as time-of-day and day-of-week are encoded into cyclical numeric representations, location clusters are encoded as embedding indices, and categorical activity types and preference categories are encoded using learned embeddings. The server serializes sequences of such feature vectors representing, for example, the last N days of lifestyle events for the user. These sequences are used as auxiliary input to the generative AI model alongside natural-language prompt sentences.

In one embodiment, the server hosts or accesses a generative AI model based on a neural network architecture such as a transformer. The generative AI model includes an input layer accepting tokenized text, multiple self-attention layers, feedforward layers, and an output layer predicting token probabilities. The model is trained using an autoregressive objective function. During training, the model minimizes a cross-entropy loss between predicted tokens and ground-truth tokens on large-scale text corpora, including dialogues, descriptions of activities, and schedule-like data. The model parameters, including attention weights and feedforward weights, are updated using gradient-based optimization methods such as stochastic gradient descent with adaptive learning-rate adjustment. In some embodiments, the model is further fine-tuned on domain-specific data containing pseudo-schedules, recommendation dialogues, and user-intent annotations. The fine-tuning process uses task-specific prompts and target outputs, and the server logs gradient norms and validation loss values to avoid overfitting.

To adapt the generative AI model to individual users without full retraining, the server uses a parameter-efficient tuning method such as adapter layers, low-rank adaptation, or prompt tuning. The server maintains user-independent base weights on a hardware accelerator such as a graphics processing unit and maintains user-specific adapter parameters in memory. When processing a particular user's data, the server activates the corresponding adapter, which slightly modifies intermediate activations of the transformer layers. This approach reduces computational cost and memory overhead compared to training or storing a full new model per user, thereby improving scalability.

The server generates a first prompt sentence that encodes context information describing the user's current and historical lifestyle situation. The server composes the prompt sentence using template-based logic and dynamically generated content. An example of such a prompt sentence is:
“You are an assistant that analyzes a person's lifestyle based on their schedule, preferences, and past activities.
User context:
   Schedule: Watch a movie this weekend.
   Past behavior: Frequently watches movies on Saturday evenings.
   Preferences: Science fiction and action movies.
   Current location: City center on Friday evening.
Using this context, infer the user's current situation, interests, and likely near-future behavior. Describe the inferred situation in a concise paragraph.”

The server appends auxiliary markers representing encoded feature vectors if the implementation uses multi-modal conditioning. The server tokenizes the prompt sentence, converts tokens to numerical identifiers, and passes them to the input of the generative AI model. The server controls generation parameters such as maximum number of output tokens, sampling temperature, and nucleus sampling threshold. By systematically constructing prompt sentences with explicit context and constraints, the server ensures that the generative AI model's internal attention mechanism is directed to relevant parts of the user's history, which improves estimation precision and reduces variance in generated outputs compared to ad-hoc or generic prompts.

The server receives an output sequence from the generative AI model corresponding to the first prompt sentence. The server decodes the sequence into natural-language text representing estimation information. The server then parses this text to extract structured fields such as inferred primary intent (e.g., “visit a cinema”), inferred time window (e.g., “Saturday evening”), inferred preference refinement (e.g., “latest science fiction releases”), and situational modifiers (e.g., “likely with a friend,” “prefers places near current location”). The server uses rule-based pattern matching and optionally a lightweight classifier model to convert free-form natural language into structured estimation information. This combination of generative inference followed by deterministic parsing is an example of a non-conventional hybrid architecture that leverages the expressiveness of a generative AI model while preserving deterministic downstream control, improving interpretability and facilitating subsequent ranking computations.

The server then constructs a second prompt sentence aimed at generating concrete proposal information for lifestyle improvement. The server includes structured estimation information and explicit generation instructions. An example of such a prompt sentence is:
“Based on the following inferred situation, generate personalized suggestions that improve the user's quality of life.
Inferred situation: The user is likely going to watch a movie this Saturday evening in the city center and prefers science fiction and action movies. The user has around 3 free hours and usually goes out with one friend.
Task:
   Propose 3-5 specific movie-related suggestions.
   Include at least one time-management tip and one health-related tip (for example, walking or light exercise).
Output format: A short list of bullet points, each with a title and 1-2 sentences of explanation.”

The server tokenizes this second prompt sentence and feeds it to the generative AI model. The model generates a list of concrete proposals. The server parses the output into discrete proposal units, each with a title, a description, and tags such as “time-management,” “health,” or “pre-movie activity.” By structuring the proposals in this way, the server can programmatically associate them with external content and control their display priority on the terminal.

The server acquires candidate information from external information providing devices such as advertisement servers or content distribution platforms. The server transmits query parameters derived from the estimation information, including inferred location area, time window, and interest categories, and receives a set of candidate content items. Each candidate item includes metadata such as content category, geographic coverage, validity period, and relevance scores computed by the external provider. The server normalizes these metadata and stores the candidate items in a temporary table-type structure.

The server computes a degree of relevance between each candidate item and the estimation information and proposal information. The server defines a relevance function that combines multiple factors: category similarity between the candidate item and the inferred interest categories, distance between the item's coverage area and the user's current or inferred location, overlap between the item's valid time window and the inferred time window for the user's activity, and textual similarity between proposal titles and item descriptions using vector embeddings. The server represents text fields of proposals and candidate items as embedding vectors using a pre-trained language embedding model and computes cosine similarity as one component of the relevance score. The server aggregates these components with weighted coefficients. The weights can be determined empirically or adjusted over time based on feedback performance. By using this multi-factor relevance function, the server can more accurately rank content items than traditional single-factor targeting, leading to lower communication overhead because fewer low-relevance items need to be transmitted to the terminal.

The server integrates the top-ranked candidate items with the proposal information. For each proposal, the server associates zero or more candidate items whose relevance exceeds a threshold. The server then constructs display-structured information that groups proposals and associated external items into sections, assigns layout attributes, and includes metadata such as validity-period information and priority information. The server computes validity-period information by combining time information from the estimation information (for example, “Saturday 18:00-21:00”) and validity windows from candidate items. The server computes priority information by considering the relevance score, urgency (time proximity), and user preference weights. The server encodes these attributes as machine-readable metadata attached to each proposal and external item.

The server transmits the display-structured information to the terminal. The terminal parses the display-structured information and uses the validity-period information and priority information to control a presentation order and a presentation mode on the display device. For example, the terminal can highlight high-priority proposals in a larger font or at the top of the screen and can suppress or gray out proposals whose validity period has expired. By moving the decision on which items to show or hide into the server's metadata and the terminal's rendering logic, the system can avoid repeatedly requesting updated information from the server, which reduces network traffic and improves responsiveness.

The terminal also records operation history when the user interacts with proposals and external items. The user may tap a movie suggestion to view more details, scroll past a suggestion without interaction, or explicitly dismiss a suggestion. The terminal logs these operations with timestamps and item identifiers and periodically sends aggregated behavior history information back to the server. The server incorporates this feedback into the lifestyle-related information table and the learning data set. The server can, for example, adjust internal feature weights, modify prompt sentence templates (e.g., reduce certain categories of proposals), or update relevance function coefficients. This closed-loop feedback mechanism allows the system to improve predictive accuracy and personalization without requiring manual rules or static configurations, and it constitutes a non-conventional use of user interaction data in conjunction with generative modeling.

From a technical standpoint, the described combination of structured data preprocessing, context-rich prompt construction, multi-stage generative inference, deterministic parsing, multi-factor relevance ranking, and metadata-driven presentation control produces several concrete improvements in computer technology. First, the server's use of vectorized table and numerical operations, together with optimized data structures, reduces the computational complexity of preprocessing and feature extraction compared to naïve or row-wise operations, enabling faster processing of large-scale lifestyle logs. Second, the prompt construction mechanism, which encodes carefully selected context and generation constraints, improves the efficiency of the generative AI model by focusing its attention on relevant parts of the user's history, reducing redundant computation due to off-topic generation. Third, the hybrid architecture, where generative outputs are parsed into structured estimation information and proposals, allows subsequent ranking and display algorithms to operate on machine-readable fields rather than raw text, which leads to more efficient and accurate relevance scoring and reduces downstream computational overhead.

Moreover, the use of parameter-efficient adaptation methods in the generative AI model reduces the need to store multiple full model instances and allows the server to scale to a large number of users with limited hardware resources. This reduces memory consumption and energy usage in the data center. The integration of validity-period information and priority information at the server side, and the corresponding presentation control at the terminal side, reduces unnecessary data transmissions and user interface updates, lowering network load and processing burden on the terminal.

The system also employs rules and procedures that differ from conventional human-based or purely rule-based recommendation approaches. For example, instead of manually designed decision trees or fixed scoring formulas, the system uses transformer-based sequence modeling with learned attention patterns to derive latent relationships between lifestyle events and preferences. The server then applies non-linear embeddings for textual and categorical features and uses learned or tunable weightings in the relevance function. These mechanisms exploit high-dimensional pattern recognition that is not feasible with manual rules, resulting in improved estimation accuracy and reduced false positives in recommendation.

In alternative embodiments, the server may employ different generative AI models, such as encoder-decoder architectures or recurrent neural networks, and may deploy them on different hardware configurations, such as specialized accelerators. The server may also vary the structure of the prompt sentences, for example by including explicit slot markers for structured fields or by using few-shot examples within the prompt to guide the generative behavior. The terminal may be a wearable device, a vehicle-mounted device, or a stationary computing device, and the position detection and motion detection devices may be integrated differently depending on the form factor. In some embodiments, the server may offload certain lightweight preprocessing or embedding computations to the terminal for further reduction of network latency and server load.

Through these embodiments, the server and the terminal jointly implement a technically specific data-processing pipeline that goes beyond abstract data manipulation or generic business processing. The system improves the way in which heterogeneous lifestyle-related data are preprocessed, encoded, and supplied to a generative AI model, and it provides concrete mechanisms for controlling and exploiting the model's outputs to drive real-time, context-sensitive presentation on user devices, resulting in measurable improvements in processing speed, accuracy, data management, computational efficiency, and communication overhead.

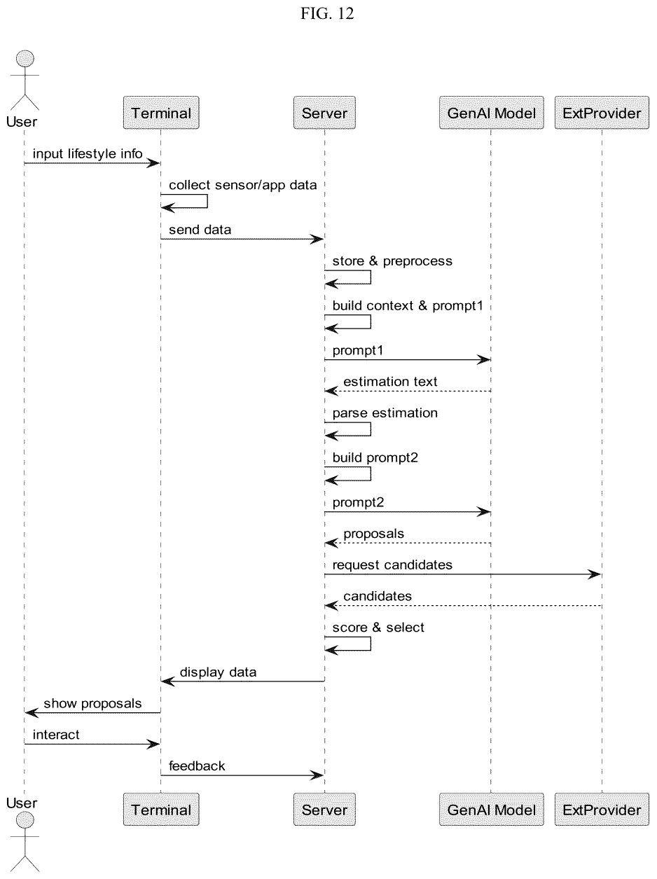

The following describes the processing flow using FIG. 12.

### Step 1

The user provides lifestyle-related information via the terminal.

The user inputs schedule information, preference information, and behavior information using an application running on the terminal, for example by typing “Watch a movie this weekend,” selecting preferred genres, or registering recurring activities such as “gym on Tuesday evening.”

Input: Raw user inputs such as free-text descriptions, selected options, timestamps, and simple flags indicating preferences.

The terminal converts these raw inputs into structured fields (for example, ‘schedule_text’, ‘preference_tags’, ‘time_range’) and attaches metadata including a user identifier, a device identifier, and a local timestamp.

Output: A structured user lifestyle-related record stored temporarily in the terminal's memory.

### Step 2

The terminal collects sensor-based and application-based information.

The terminal reads position information from a position detection device (for example, a GPS receiver or network-based location module) and motion information from a motion detection device (for example, an accelerometer or gyroscope). The terminal also accesses logs or interfaces of application software such as a calendar application, a media consumption application, or a social communication application to obtain electronic record information (for example, event entries, consumed content, and activity logs).

Input: Sensor readings (coordinates, speed, acceleration) and application logs (events, content IDs, time stamps).

The terminal aggregates these values with the user-entered lifestyle-related record, normalizes units (for example, converting time zones, distance units), and generates a unified data message.

Output: A structured data message containing user lifestyle-related information, sensor measurements, and electronic record information.

### Step 3

The terminal transmits the unified data message to the server.

The terminal opens a secure network connection to the server and sends the unified data message using a network protocol such as HTTPS. The terminal may compress the message payload to reduce bandwidth usage.

Input: The unified data message generated in Step 2.

The terminal wraps the message in an authenticated request, including a user token and device identifier, and ensures that the message format conforms to a predefined schema.

Output: A network request containing the unified data message delivered to the server.

### Step 4

The server receives and stores the lifestyle-related information.

The server accepts the incoming network request, validates authentication credentials, and checks the structure of the received data against a stored schema.

Input: The unified data message containing user lifestyle-related information, sensor measurements, and electronic records.

The server writes each element to corresponding tables in a relational database (for example, a user lifestyle events table, a sensor measurements table, and an application logs table), creating or updating rows keyed by user identifier and timestamp. The server may create indexes on time and user fields to accelerate subsequent queries.

Output: Persisted lifestyle-related records stored in the database and indexed for retrieval.

### Step 5

The server constructs a table-type data structure and performs preprocessing.

The server queries the database for a set of recent and historical records for the user, for example, all events and measurements in the last N days.

Input: Database rows representing lifestyle events, sensor measurements, and application logs.

The server loads these rows into a table-type data structure such as a data frame, with each row representing an event and each column representing a feature (for example, ‘timestamp’, ‘location_lat’, ‘location_lon’, ‘activity_type’, ‘preference_tag’, ‘sensor_value’). The server performs data processing:
Missing-value completion: fills missing coordinates by interpolating between neighboring known points; fills missing activity types by majority vote in the surrounding time window.
Outlier removal: detects outliers in numeric features (for example, unrealistic speed) using statistical thresholds (z-scores or interquartile ranges) and removes or caps them.
Feature transformation: converts timestamps to derived features such as “day of week,” “hour of day,” and encodes categorical fields as numeric codes.

Output: A cleaned and feature-enriched table-type data structure forming a learning data set candidate.

### Step 6

The server generates feature vectors and a context summary.

The server takes the cleaned table and encodes each row into a numerical feature vector by mapping categorical values to embeddings or indices and normalizing numeric values.

Input: The cleaned table-type data structure from Step 5.

The server arranges these feature vectors in temporal order to form sequences representing user behavior over time. In parallel, the server summarizes key aspects (for example, most frequent locations, typical activity times, dominant preferences) into a short textual description.

Output: A sequence of numerical feature vectors and a textual context summary describing the user's lifestyle pattern.

### Step 7

The server constructs a first prompt sentence for the generative AI model.

The server combines the textual context summary with the latest user-entered schedule and preferences.

Input: The textual context summary and the most recent lifestyle-related records (for example, “Watch a movie this weekend,” preferred genres, current location).

The server composes a structured prompt sentence, for example:
“You are an assistant that analyzes a person's lifestyle based on their schedule, preferences, and past activities.
User context:
   Schedule: Watch a movie this weekend.
   Past behavior: Frequently watches movies on Saturday evenings.
   Preferences: Science fiction and action movies.
   Current location: City center on Friday evening.
Using this context, infer the user's current situation, interests, and likely near-future behavior. Describe the inferred situation in a concise paragraph.”

The server may embed a reference to the feature vector sequence (for example, as tags indicating “last 7 days of activities”) when the generative AI model supports additional conditioning.

Output: A first prompt sentence ready to be tokenized and supplied to the generative AI model.

### Step 8

The server invokes the generative AI model to obtain estimation information.

The server tokenizes the first prompt sentence into tokens and converts tokens to numerical identifiers required by the generative AI model.

Input: The first prompt sentence and, optionally, the feature vector sequence as auxiliary conditioning data.

The server passes the token sequence (and optional auxiliary vectors) to a generative AI model running on a hardware accelerator, such as a transformer-based model deployed on a graphics processing unit. The model executes attention and feedforward computations over the token sequence, using learned weights, and outputs a probability distribution over tokens at each step. The server decodes the generated tokens into a text response that describes inferred user interests and likely behavior.

Output: A natural-language text representing estimation information about the user's situation and interests.

### Step 9

The server parses the estimation information into structured fields.

The server analyzes the generated text to extract structured attributes such as inferred intent, inferred time window, inferred content category, and additional qualifiers.

Input: The natural-language estimation text from Step 8.

The server applies rule-based parsing and pattern matching (for example, regular expressions or template matching) and may optionally apply a lightweight classifier to identify segments corresponding to key fields. The server maps identified phrases to structured representations, such as an intent label (“go_to_cinema”), a time interval (“Saturday evening”), and a category (“science_fiction_movie”).

Output: Structured estimation information stored in memory or in an estimation record.

### Step 10

The server constructs a second prompt sentence to generate proposal information.

The server uses the structured estimation information to define specific generation tasks for the generative AI model.

Input: The structured estimation information including inferred intent, time window, location, and preference categories.

The server composes a second prompt sentence, such as:
“Based on the following inferred situation, generate personalized suggestions that improve the user's quality of life.
Inferred situation: The user is likely going to watch a movie this Saturday evening in the city center and prefers science fiction and action movies. The user has around 3 free hours and usually goes out with one friend.
Task:
   Propose 3-5 specific movie-related suggestions.
   Include at least one time-management tip and one health-related tip (for example, walking or light exercise).
Output format: A short list of bullet points, each with a title and 1-2 sentences of explanation.”

Output: A second prompt sentence specifying the required structure and content of the proposals.

### Step 11

The server generates concrete proposal information using the generative AI model.

The server tokenizes the second prompt sentence and feeds the resulting tokens to the generative AI model.

Input: The second prompt sentence.

The generative AI model performs sequence generation by repeatedly computing attention and feedforward operations and sampling or selecting the most probable output tokens under specified generation parameters. The server collects the generated text, which typically appears as a list of proposed actions or recommendations. The server separates the list into individual items by detecting bullet markers or sentence boundaries and assigns each item a title and description field.

Output: A set of structured proposal items, each representing a concrete suggestion for the user.

### Step 12

The server acquires and normalizes external candidate information.

The server sends a query to one or more external information providing devices, such as advertisement servers or content providers, using request parameters derived from the estimation information, such as categories (“movies,” “science fiction”), location area, and time window.

Input: The structured estimation information specifying inferred interests, time, and location.

The external devices return a list of candidate items with metadata such as content type, geographic applicability, validity period, and pre-computed scores. The server normalizes fields (for example, unifies time formats and location formats) and loads the items into a table-type data structure.

Output: A table of candidate external items with standardized metadata.

### Step 13

The server computes relevance scores between proposals, estimation information, and candidate items.

The server calculates a degree of relevance for each candidate item by combining multiple similarity measures.

Input: The structured estimation information, the set of proposal items, and the table of candidate external items.

The server computes categorical similarity between candidate categories and inferred categories, computes geographic distance between the user's location and item coverage areas, and computes temporal overlap between item validity periods and the inferred time window. The server also generates text embeddings for proposal descriptions and candidate descriptions using a language embedding model, then computes cosine similarity between embeddings. The server aggregates these components into a single relevance score by applying weighted summation.

Output: Candidate items annotated with composite relevance scores.

### Step 14

The server selects, ranks, and groups information for presentation.

The server sorts candidate items by relevance score and selects the top-ranked items above a certain threshold.

Input: Candidate items with associated relevance scores and the proposal items.

The server groups selected candidate items with compatible proposal items (for example, linking a cinema coupon to a “book tickets in advance” proposal). The server assigns validity-period information by intersecting the user's inferred time window with item validity periods, and calculates priority information based on relevance, urgency, and user-preference weightings.

Output: An integrated set of proposal items and external information, each with validity-period information and priority information.

### Step 15

The server generates display-structured information and transmits it to the terminal.

The server encodes the integrated set of information into a display-structured format, specifying logical sections, display order, and presentation modes (for example, highlighted or standard).

Input: The grouped proposals and selected external items, together with their validity-period and priority information.

The server organizes items according to priority and tags each item with display attributes (for example, position in list, emphasis style). The server then sends this display-structured information to the terminal via the network interface.

Output: A response message containing display-structured information, including proposals, external items, and associated metadata.

### Step 16

The terminal presents the information and captures user interactions.

The terminal receives the display-structured information and maps each proposal and external item into graphical components on the user interface.

Input: The display-structured information received from the server.

The terminal orders and styles items based on the provided priority and validity-period information, hides expired items, and highlights urgent or highly relevant items. When the user interacts with these items (for example, taps on a proposal, opens a link, or dismisses a suggestion), the terminal records these operations as operation history, including timestamps and item identifiers. The terminal periodically packages the operation history as behavior history information and sends it back to the server for use in subsequent processing.

Output: A visual presentation to the user on the display device and logged behavior history information transmitted to the server.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recommendation systems that utilize machine learning or artificial intelligence typically rely on static rule sets, coarse user segments, or manually engineered feature pipelines. Such systems often treat user activity logs and location logs as generic input data and do not provide an integrated mechanism for (i) cleaning heterogeneous sensor streams, (ii) inferring a fine-grained user situation in real time, and (iii) converting that inferred situation into an effective natural-language prompt for a generative AI model. As a result, the quality and consistency of generated recommendations are highly dependent on ad hoc prompt design and manual tuning, rather than on a reproducible and machine-optimizable pipeline.

In addition, existing systems seldom exploit user feedback at the level of model inputs and prompt sentences. While some systems log whether a recommendation is clicked, they do not systematically associate such feedback with the underlying situation estimation result or with the exact prompt sentence used, nor do they use that association to adapt the machine learning algorithm or the prompt-generation logic itself. Consequently, the system cannot effectively improve its inference accuracy or its prompt construction over time, leading to suboptimal use of computing resources and degraded user experience.

Furthermore, the processing of noisy sensor data on the server side is frequently implemented in an ad hoc manner without standardized preprocessing steps such as missing-value completion, outlier removal, and feature normalization that are tightly coupled to the downstream inference and generation tasks. This lack of a structured, end-to-end data processing and prompt-generation pipeline causes unnecessary computation, complicates model maintenance, and hinders deployment and scaling in networked environments.

Accordingly, there is a need for a computer-implemented technique that improves the overall functioning of the server-side processing pipeline by (a) systematically preprocessing time-series user activity information and location information received from terminals, (b) inferring a user's current situation using a machine learning algorithm, (c) automatically generating structured prompt sentences encoding context information for a generative AI model, and (d) updating the inference and prompt-generation components based on explicit user interaction feedback. Such a technique should enhance the reliability, adaptability, and computational efficiency of recommendation generation, thereby improving the operation of computer systems that provide context-aware assistance to users.

The specific processing by the specific processing unit 290 of the data processing device 12 in Example 2 is realized by the following means.

The present invention provides a server comprising a processor configured to receive time-series user activity information and location information from a terminal via a communication network, the time-series information being automatically obtained by sensing devices of the terminal; to read the received time-series information from a storage device and perform preprocessing including missing-value completion processing, outlier removal processing, and feature normalization processing to generate an input data set for machine learning; to input the input data set into a machine learning algorithm and obtain a situation estimation result indicating a current situation or behavioral state of a user; to extract context information including at least a user behavior pattern, a time period, and a location category on the basis of the situation estimation result; to generate a prompt sentence to be input to a generative artificial intelligence model by describing the context information in a structured manner together with at least one of time information, location information, and activity trend information; to instruct the generative artificial intelligence model, by using the prompt sentence, to generate recommendation information and obtain a natural-language recommendation sentence from the generative artificial intelligence model as a generation result; to transmit the recommendation sentence as notification data to the terminal; and to obtain operation information of the user from the terminal after the recommendation sentence is presented, store the operation information in association with the situation estimation result and the prompt sentence, and update at least one of the machine learning algorithm and a generation method of the prompt sentence on the basis of the operation information. This enables an improved computer-centric processing pipeline in which noisy sensor data streams are automatically converted into clean feature sets, user situations are inferred with higher accuracy, context-rich prompt sentences are generated in a reproducible form for the generative AI model, and both the inference model and the prompt construction logic are adaptively refined using user interaction feedback, thereby enhancing the overall efficiency, responsiveness, and reliability of server-based recommendation generation.

The term “time-series user activity information” refers to digitally recorded data representing changes in a user's physical movements or interactions over time, including sequential measurements such as step counts, travel distances, posture changes, or device operation events, each associated with a time stamp.

The term “location information” refers to digitally encoded data indicating a geographical position of a user or a terminal, including coordinates, region identifiers, or categories derived from positioning technologies such as satellite-based systems, wireless network positioning, or proximity sensing.

The term “terminal” refers to an electronic apparatus operated by or carried by a user, including but not limited to a mobile communication device, a wearable device, or a general-purpose computing device capable of sensing, processing, and transmitting data.

The term “positioning device” refers to a hardware and software combination in a terminal that measures or estimates geographic position, including modules for satellite-based positioning, wireless network-based positioning, or proximity-based positioning.

The term “motion detection device” refers to a hardware and software combination in a terminal that detects changes in movement or orientation, including inertial sensors, acceleration sensors, angular velocity sensors, and associated processing logic.

The term “communication network” refers to a wired or wireless data communication infrastructure enabling data exchange between a terminal and a server, including local networks, wide-area networks, and public packet-switched networks.

The term “storage device” refers to a hardware component or virtualized resource for storing digital data, including nonvolatile memory, magnetic storage, optical storage, or network-attached storage used to retain user data, intermediate results, and model parameters.

The term “preprocessing” refers to a set of computational operations applied to raw data to produce data suitable for machine learning, including missing-value completion, outlier removal, feature transformation, and normalization.

The term “missing-value completion processing” refers to a computational operation that detects absent or undefined elements in data records and replaces them with substitute values determined by predetermined rules, statistical measures, or learned models.

The term “outlier removal processing” refers to a computational operation that identifies data points deviating from expected patterns according to specified criteria and excludes or corrects those data points to reduce noise and improve model robustness.

The term “feature normalization processing” refers to a computational operation that scales or transforms numerical features into a standardized range or distribution, thereby stabilizing numerical behavior of machine learning algorithms and facilitating comparison among features.

The term “input data set for machine learning” refers to a structured collection of processed data records formatted as vectors, matrices, or tensors that are compatible with a machine learning algorithm and used for inference or training.

The term “machine learning algorithm” refers to a computational technique that automatically derives patterns or predictive rules from data, including but not limited to statistical models, decision tree models, neural network models, and ensemble models.

The term “situation estimation result” refers to an output of a machine learning algorithm representing an inferred state of a user, such as an activity context or behavioral mode, which may include a class label, a probability distribution, or continuous scores.

The term “context information” refers to a set of data elements that characterize circumstances surrounding a user, including at least a user behavior pattern, a time period, and a location category, and optionally other environmental or historical attributes.

The term “user behavior pattern” refers to a representation of recurring characteristics in a user's actions over time, derived from activity records, schedules, or historical interactions, and indicating tendencies such as commuting habits, working hours, or leisure preferences.

The term “time period” refers to a temporal descriptor associated with an event or state, including specific points in time, time intervals, time-of-day segments, and day-of-week or calendar-based categories.

The term “location category” refers to a classification label assigned to a physical or logical place, such as home, workplace, commercial area, or transit route, derived from raw location information or external map data.

The term “activity trend information” refers to derived indicators of changes or tendencies in user activity over a time window, such as increasing movement, decreasing movement, stable sedentary behavior, or periodic activity patterns.

The term “generative artificial intelligence model” refers to an artificial intelligence system that produces new data, such as text or other content, in response to input, based on parameters learned from training data, including but not limited to generative language models.

The term “prompt sentence” refers to a structured sequence of natural-language tokens or equivalent representation provided as an input to a generative artificial intelligence model, specifying context, constraints, or desired output characteristics.

The term “natural-language recommendation sentence” refers to a text sequence expressed in a human language that provides advice, suggestions, or guidance tailored to a user's inferred situation and generated by a generative artificial intelligence model.

The term “notification data” refers to digital information prepared for delivery to a terminal for user presentation, including at least a recommendation sentence and optionally additional metadata such as titles, identifiers, or action parameters.

The term “operation information of the user” refers to data describing user interactions with a terminal or an application, such as selection actions, dismissal actions, or navigation behaviors, captured after presentation of a recommendation sentence.

The term “generation method of the prompt sentence” refers to a procedure or algorithm executed by the processor to construct a prompt sentence, including rules, templates, parameter settings, and context selection strategies.

The term “update” refers to a modification of parameters, rules, or structural components of a machine learning algorithm or a prompt generation procedure, based on new data or feedback, to change future inference behavior or prompt content.

In one embodiment, the system includes a server, a plurality of terminals, and a communication network connecting the server and the terminals. The server comprises at least one processor, a main memory, a nonvolatile storage device, and a network interface. The terminals comprise mobile communication devices or wearable devices equipped with a positioning device, a motion detection device, a display device, and a wireless communication interface.

The terminal acquires time-series user activity information by using the motion detection device, which includes an acceleration sensor and a gyroscopic sensor controlled by an operating system. The terminal also acquires location information by using the positioning device, which includes a satellite-based positioning module, a wireless network-based positioning module, and an associated location service of the operating system. The terminal converts raw sensor signals into digital records each containing at least a user identifier, a timestamp, a latitude value, a longitude value, a step count, a travel distance, and an estimated energy consumption value. The terminal stores these records in a local database, such as a relational database managed by a database engine, and transmits batches of the records to the server via a secure communication protocol.

The server receives the time-series records from the terminals through the network interface and stores the records into a server-side data repository, such as a relational database management system. The server executes software modules implemented, for example, using a general-purpose programming language and a data analysis library. The server loads a group of records for one user during a predetermined time window into a matrix-like data structure in the main memory. The server performs missing-value completion processing by computing, for each numerical field, a representative statistic such as a mean value or a median value over historical records of the same user and substituting that statistic for missing entries. The server performs outlier removal processing by calculating, for each feature, a deviation score such as a z-score or an interquartile range-based score and discarding or clipping records whose deviation exceeds a threshold. The server performs feature normalization processing by applying either standardization, which maps each feature to zero mean and unit variance, or min-max scaling, which maps each feature to a predetermined numeric interval. By performing these preprocessing operations in a consistent sequence, the server converts heterogeneous and noisy sensor streams into a compact numerical feature matrix that is directly consumable by a machine learning algorithm, thereby improving numerical stability, convergence behavior, and inference accuracy.

The server applies a machine learning algorithm to the normalized feature matrix in order to compute a situation estimation result. In one embodiment, the server employs a neural network model having an input layer corresponding to features such as normalized step count, normalized travel distance, normalized energy consumption, time-of-day encoding, day-of-week encoding, and an embedding representing a location category. The server configures one or more hidden layers as fully connected layers with nonlinear activation functions and optionally dropout units to prevent overfitting. The server provides an output layer that yields a probability distribution over a finite set of user situation classes, such as “working,” “commuting,” “taking a break,” and “relaxing at home.”

The server trains the neural network model offline prior to deployment by using historical labeled data that associates sensor-derived feature vectors with ground-truth situation labels. During training, the server defines a loss function such as cross-entropy between predicted class probabilities and true labels. The server updates the model weights using an iterative optimization method, such as stochastic gradient descent or a variant thereof, with backpropagation of gradients through the network layers. The server can perform data augmentation on the training dataset, for example by adding noise to numeric features, randomly masking some time steps, or slightly perturbing timestamps, to increase robustness against sensor variability. The server stores the trained model parameters in the nonvolatile storage device and loads them into the main memory at runtime. This training procedure enables the server to implement a fine-grained, non-linear mapping from raw sensor patterns to user situation labels that would not be feasible with simple rule-based logic.

The server, after obtaining the situation estimation result for a given user and time window, generates context information. The server derives a user behavior pattern by aggregating past situation estimation results and computing statistics such as typical working hours, typical commuting routes, and frequency of sedentary periods. The server also categorizes the current time into a time period, such as morning, midday, afternoon, evening, or night, and assigns the current location into a location category, such as home area, workplace area, commercial area, or transit corridor, based on geographic clustering or mapping to predefined regions. The server further computes activity trend information, such as whether the user's movement intensity is increasing, decreasing, or stable over a recent time window.

The server constructs a prompt sentence to be input to a generative AI model by embedding the situation estimation result and the context information into a structured natural-language description. The server uses a prompt-generation module that selects template phrases and fills in parameter slots with up-to-date values, thereby producing a reproducible and machine-tunable prompt structure. For example, the server may construct a prompt sentence such as:
“The user is currently in the following situation:
   Time: 09:00 on a weekday
   Location: office area (latitude 35.6804, longitude 139.7690)
   Activity: low movement, low step_count, continuous desk work
   Inferred context: working
Using this information, please generate a short, friendly suggestion to improve either work efficiency or relaxation during the next break.”

In another example, the server may construct a prompt sentence such as:
“The system has inferred that the user is currently working at the office and that lunchtime is in 30 minutes. The user's location is near several cafés. Please generate a short, friendly suggestion message proposing a lunch plan, including a visit to a nearby café, in no more than 40 words.”

The server sends the prompt sentence to a generative AI model that is implemented as a parametric generative language model. The generative AI model may be realized as a transformer-based neural network having an encoder-decoder or decoder-only architecture with multiple attention layers, feed-forward sublayers, and positional encodings. The server supplies the prompt sentence as a sequence of tokens to the generative AI model and configures generation parameters including a maximum token length, a temperature value controlling randomness, and optionally a top-k or top-p sampling configuration. The generative AI model computes, for each timestep, a probability distribution over the vocabulary and selects tokens according to the configured sampling method. The resulting sequence of tokens is combined into a natural-language recommendation sentence.

The server receives the recommendation sentence and performs optional post-processing, such as truncating the text to a predetermined maximum length, filtering undesired terms, and attaching metadata such as a category label or an action type. The server then encapsulates the recommendation sentence into notification data and transmits the notification data to the corresponding terminal via a push notification infrastructure. The terminal receives the notification data, passes it to an application process through the operating system's notification service, and presents the recommendation sentence on the display device. The terminal may present additional user interface elements such as buttons for accepting, dismissing, or requesting alternative recommendations.

The user views the recommendation on the terminal and may interact with the displayed content. For example, the user may tap a button to open a mapping application showing nearby cafés or tap a button to start a relaxation audio program. The terminal records the user's operation information, including actions such as “opened recommendation,” “dismissed recommendation,” or “requested different suggestion,” and transmits this feedback information back to the server.

The server stores the operation information in association with the original situation estimation result and the prompt sentence used. The server aggregates such interaction logs over time and uses them as supervision signals to refine both the machine learning algorithm and the prompt-generation logic. For example, the server can train an additional model that predicts a likelihood of user engagement based on situation features and candidate prompt structures, and can adaptively prioritize prompts that historically yield higher engagement in similar contexts. The server also can adjust thresholds for situation classification, reweight features in the neural network, or modify template selection rules in the prompt-generation module. By doing so, the server implements an adaptive optimization loop that continuously improves recommendation relevance and reduces unnecessary communications and processing for recommendations that are unlikely to be effective.

This overall architecture yields several technical effects. Because the server normalizes and cleans time-series sensor data in a standardized manner before inference, the server reduces the variance in model input space and decreases the number of erroneous classifications caused by sensor noise or missing records. This leads to improved accuracy of the situation estimation result and reduces the number of unnecessary invocations of the generative AI model, which in turn lowers computational load and network bandwidth usage. Because the server encodes rich context information into a structured prompt sentence, the generative AI model can produce more targeted text with fewer tokens, improving both response quality and generation latency. The template-based, structured prompt construction also allows the server to systematically optimize prompt layout and parameters based on user feedback, rather than relying on manual trial-and-error.

In addition, the integration of situation estimation, context extraction, prompt construction, generative text generation, and feedback-based updating inside a single server-controlled pipeline improves the functioning of the computer system as a whole. The server transforms raw sensor measurements, which are high-frequency, noisy, and device-dependent, into compact, semantically meaningful representations suitable for both discriminative and generative models. The server thereby increases server-side processing efficiency, reduces storage overhead by discarding outliers and redundant data, and enables more predictable use of computing resources such as memory and processor time. The feedback-based update mechanism allows the system to adapt models and prompts without requiring manual rule editing or system downtime, which further enhances robustness and scalability.

Alternative embodiments are also possible. In one embodiment, the server uses a sequence model, such as a recurrent neural network or a temporal convolutional network, to process sequences of feature vectors over time, thereby capturing temporal dependencies in user behavior. In another embodiment, the server employs a clustering algorithm to group users by similar behavior patterns and applies cluster-specific neural network parameters or prompt templates to improve personalization. In yet another embodiment, the server deploys the generative AI model in a separate computing node or accelerator device and communicates with that node through a specialized protocol while keeping the preprocessing and prompt-creation logic on the main server.

The system is not limited to any particular implementation language or hardware, as long as the server can execute the preprocessing modules, the situation estimation algorithm, the prompt-generation logic, and the interface to the generative AI model, and as long as the terminals can capture sensor data and present recommendation sentences. The described embodiments illustrate how the server, the terminals, and the associated processes cooperate to implement the claimed invention in a concrete and technically meaningful way, allowing a person skilled in the art to realize the invention in various computing environments.

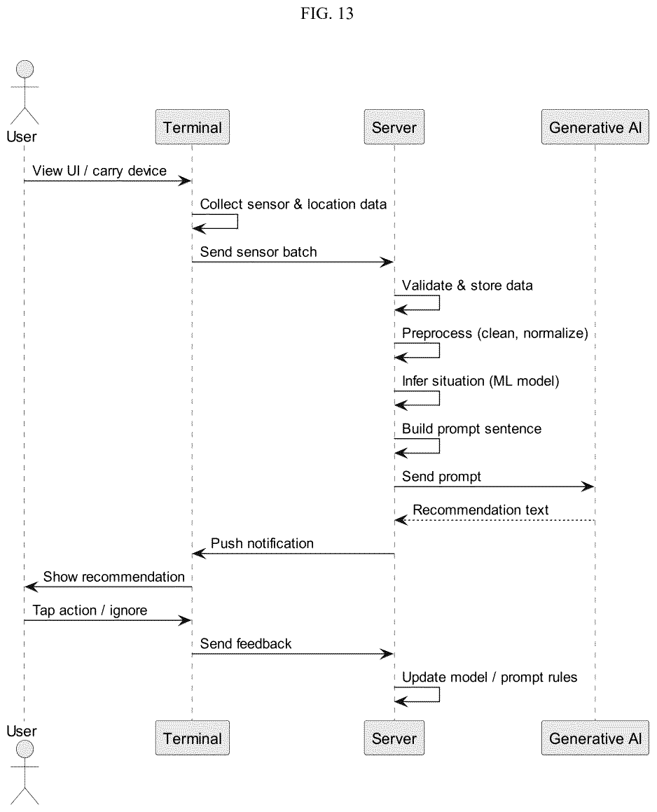

The following describes the processing flow using FIG. 13.

### Step 1

The terminal acquires raw sensor signals as input, including acceleration values, angular velocity values, and radio signals from positioning sources.

The terminal calls an operating system API to read measurements from a motion detection device and a positioning device at fixed time intervals. The terminal converts the raw sensor signals into a structured record that includes at least a user identifier, a timestamp, a latitude value, a longitude value, a step count, a travel distance, and an estimated energy consumption value.

The terminal outputs a sequence of structured sensor records and stores them temporarily in a local storage area.

### Step 2

The terminal uses the stored sensor records as input.

The terminal aggregates the records into batches based on a time window or a record count and encodes each record in a data-interchange format, adding metadata such as a device identifier and a software version. The terminal establishes a secure connection to the server over a communication network and transmits each batch using a network protocol.

The terminal outputs transmitted data packets that contain multiple structured sensor records.

### Step 3

The server receives the transmitted data packets as input.

The server validates the packet headers, decodes the structured records, and checks the presence and type of mandatory fields such as timestamp, latitude, longitude, and step count. The server discards invalid records, logs error events, and inserts valid records into a database table with columns for each sensor field and an index on user identifier and timestamp.

The server outputs a set of stored raw sensor records in a persistent database.

### Step 4

The server uses the stored raw sensor records for a given user and time range as input.

The server loads the records into a tabular data structure in memory, groups them by user and by fixed-length time segments, and scans each column to detect null values or placeholders indicating missing data. The server computes replacement values such as a mean or median value from historical records and fills the missing entries accordingly.

The server outputs a set of sensor records with completed values in place of missing data.

### Step 5

The server uses the completed sensor records as input.

The server calculates summary statistics such as mean, standard deviation, and percentile values for each numeric attribute and computes a deviation score for each record. The server identifies outlier records whose deviation score exceeds a predetermined threshold and removes or clips these records to limit their influence on subsequent processing.

The server outputs a filtered set of sensor records with outliers removed or adjusted.

### Step 6

The server uses the filtered sensor records as input.

The server applies a normalization formula to each numeric field, such as subtracting a mean and dividing by a standard deviation or mapping values to a fixed range. The server constructs a feature vector for each time segment that concatenates normalized step counts, normalized distances, normalized energy values, encoded time-of-day information, encoded day-of-week information, and an encoded location category derived from geographic clustering.

The server outputs a matrix of feature vectors representing time segments for the user.

### Step 7

The server uses the feature matrix as input.

The server loads a trained machine learning model into memory and arranges each feature vector to match the model's input order. The server passes the feature matrix through the model's layers, performing linear transformations, nonlinear activations, and any configured regularization operations. The server computes a probability value for each candidate situation class and selects the class with the highest probability as the estimated situation for each time segment.

The server outputs a sequence of situation estimation results, each associated with a timestamp and a user identifier.

### Step 8

The server uses the sequence of situation estimation results as input.

The server aggregates recent situation labels to derive a user behavior pattern, such as typical work intervals and commuting intervals. The server maps the current timestamp to a time period descriptor and maps the current geographic coordinates to a location category by comparing them with preconfigured geographic regions. The server computes activity trend information by comparing current feature values with those of previous time segments.

The server outputs a context information object that includes the estimated situation, the user behavior pattern, the time period, the location category, and the activity trend information.

### Step 9

The server uses the context information object as input.

The server selects a prompt template based on the estimated situation and fills parameter slots in the template with concrete values for time, location, activity level, and behavior pattern. The server arranges the filled values in a structured textual form that clearly identifies each context element, and appends an instruction specifying the type and length of recommendation to be generated.

The server outputs a complete prompt sentence ready to be supplied to a generative AI model.

### Step 10

The server uses the prompt sentence as input.

The server tokenizes the prompt sentence into a sequence of tokens according to the vocabulary of the generative AI model and sets generation parameters such as a maximum output length and a temperature value. The server sends the tokenized prompt and the parameters to the generative AI model through an interface and receives predicted tokens step by step as the model computes probability distributions and samples output tokens. The server converts the token sequence back into a text string and trims or formats the text if necessary.

The server outputs a natural-language recommendation sentence tailored to the user's current context.

### Step 11

The server uses the recommendation sentence as input.

The server encapsulates the recommendation sentence in notification data, including a title, a message body, and optional action identifiers. The server looks up a device token for the corresponding terminal and sends the notification data to a push notification service. After confirmation of successful delivery, the server stores a log entry linking the notification data to the underlying prompt sentence and situation estimation result.

The server outputs a transmitted notification that is deliverable to the terminal.

### Step 12

The terminal receives the transmitted notification as input.

The terminal invokes an operating system notification handler to extract the title, message body, and action identifiers from the notification data. The terminal displays the recommendation sentence on the display device and presents interactive elements such as buttons for accepting, dismissing, or requesting a different suggestion.

The terminal outputs visual content on the display and generates internal event signals corresponding to any user actions.

### Step 13

The user uses the displayed content and the interactive elements as input.

The user reads the recommendation sentence and chooses an action, such as opening a related application, ignoring the notification, or explicitly dismissing it. The user's touch or click on the display surface produces an event that the terminal's operating system detects and forwards to the application.

The user outputs a behavioral response that is observable as an operation event on the terminal.

### Step 14

The terminal uses the operation event as input.

The terminal converts the event into operation information including at least a type of action, a timestamp, and an identifier of the associated notification. The terminal packages the operation information into a feedback message and transmits it to the server via the communication network.

The terminal outputs a feedback data packet containing structured operation information.

### Step 15

The server receives the feedback data packet as input.

The server decodes the feedback message and associates the operation information with the corresponding notification log entry, the prompt sentence, and the situation estimation result stored previously. The server aggregates many such records to form a feedback dataset and computes statistics such as engagement rates for different prompt structures, situations, and time periods. The server updates parameters of the machine learning model or rules of the prompt-generation module by applying a learning algorithm or an optimization procedure that uses the feedback dataset as a supervision signal.

The server outputs updated model parameters and prompt-generation rules that improve future situation estimation accuracy and recommendation effectiveness.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation systems generally rely on static user profiles, coarse activity logs, or simple content-based and collaborative filtering algorithms. These systems typically treat user context as a small set of categorical attributes, such as time of day or device type, and do not deeply integrate multimodal sensor data, real-time emotional state, and subsequent user reactions into the core computation. As a result, such systems often generate proposals that are poorly aligned with a user's actual situation and emotional needs, leading to low engagement and limited improvement in user experience or quality of life.

Further, known machine learning pipelines for personalization usually perform one-way inference: a model consumes preprocessed data, outputs a prediction or recommendation, and the system presents it to the user. The feedback loop, if present, is often implemented as offline logging and batch retraining that do not adapt the model or the prompt logic for generative models in real time. In particular, when a generative AI model is used, conventional systems tend to send fixed or manually designed prompt sentences that do not systematically encode the user's current situation, emotional state, and historical effectiveness of prior proposals. This results in unstable recommendation quality, redundant or inappropriate content, and inefficient use of computational resources.

Moreover, typical emotion recognition components, when present, are loosely coupled add-ons to recommendation engines. They are not integrated into a unified architecture in which emotion estimates, sensor-based situation inference, and generative AI outputs are treated as first-class signals that drive prompt sentence generation, external service selection, and continuous learning. As a consequence, the underlying computer system cannot effectively adapt its internal models, data flows, and decision logic based on fine-grained, multimodal feedback, and thus cannot fully exploit the capabilities of modern generative AI models.

Accordingly, there is a need for an improved computer-implemented system and server architecture that: (i) acquires and fuses multimodal user data including sensor signals, application usage, and emotional state; (ii) infers user situation using machine learning techniques; (iii) automatically constructs context-rich prompt sentences for a generative AI model; (iv) maps abstract generative outputs to concrete machine-executable actions and external service identifiers; and (v) closes the loop by using user responses and emotion changes to update preference models, prompt structures, and learned parameters. Such a system should technically improve the way computers generate, select, and adapt personalized proposals by restructuring data flows, model interactions, and control logic, thereby enhancing efficiency, robustness, and responsiveness of the recommendation process itself, rather than merely automating a human decision-making workflow.

The specific processing by the specific processing unit 290 of the data processing device 12 in Application Example 2 is realized by the following means.

The present invention provides a server comprising a processor and a memory storing instructions that, when executed by the processor, cause the processor to acquire user attribute information and user activity information from one or more terminal devices, automatically collect position information, biological information, usage history information, and behavior history information via detection devices and application programs of the terminal devices, estimate an emotional state of a user based on voice information, image information, and behavior information, generate feature values from collected life-related information and the estimated emotional state and input the feature values to a machine learning model to infer a situation of the user, generate a context-dependent prompt sentence based on the inferred situation, the emotional state, and preference information of the user for causing a generative AI model to infer behavior of the user and to generate a proposal for improving quality of life of the user, input information to the generative AI model by using the prompt sentence, analyze proposal content output from the generative AI model and, by associating the proposal content with an information retrieval identifier of an external information provision service, select concrete media information, merchandise information, or action instruction information, notify the selected information to the terminal devices and control at least one of an acoustic output device, a display device, or an environment control device so as to present the proposal content to the user, and acquire response information of the user to the proposal content and a change in the emotional state of the user after presentation of the proposal content and update generation of the prompt sentence and a content of the proposal content on the basis of the response information and the change in the emotional state. This enables a technical improvement in the operation of the computer system itself by implementing an integrated, multimodal, closed-loop architecture in which situation inference, emotion estimation, prompt sentence generation for a generative AI model, mapping of abstract proposals to concrete machine-executable actions, and continuous model and preference updating are cooperatively executed, thereby enhancing computational efficiency, stability, and contextual accuracy of personalized proposals beyond what is achievable with conventional, static, or one-way recommendation pipelines.

The term “user attribute information” refers to information that characterizes a user at a general level, including demographic attributes, preference attributes, and stable profile settings, such as age range, general interests, preferred content categories, and long-term lifestyle preferences, without being limited to any particular data format or source.

The term “user activity information” refers to information indicating dynamic actions or behaviors of a user over time, including but not limited to application usage, device operation events, physical movement patterns, and temporal patterns of work, rest, and leisure activities.

The term “user terminal device” refers to an information processing apparatus operated or carried by a user, such as a portable communication device, a wearable device, a head-mounted display, or a general-purpose computing device, that can collect sensor information and execute application programs.

The term “detection device” refers to a hardware component or a combination of hardware components configured to detect physical or environmental quantities related to a user or surroundings, including sensors for position, motion, biological signals, sound, or images.

The term “application program” refers to software executed on a user terminal device that provides application-level functions, including communication, scheduling, media playback, browsing, or data collection, and that can log or expose user interactions and usage history.

The term “position information” refers to data indicating a spatial location of a user or a user terminal device, such as coordinates, region identifiers, or location categories, obtained through positioning techniques.

The term “biological information” refers to data indicative of physiological states or signals of a user, including but not limited to heart rate, heart rate variability, respiration rate, body movement intensity, or other measurable biological signals.

The term “usage history information” refers to data representing past use of software, services, or digital resources by a user, including timestamps, frequency, duration, and categories of accessed applications, services, or content.

The term “behavior history information” refers to chronological data describing actions or behaviors of a user, including movement patterns, activity types, dwell times, and sequences of interactions with devices, environments, or services.

The term “emotional state” refers to an internal affective condition of a user, such as happiness, relaxation, stress, sadness, or anger, that is estimated by computational analysis of observable signals including voice, facial expression, and behavior.

The term “voice information” refers to audio data representing speech or vocal sounds produced by a user, including signals recorded through a microphone and optionally processed for transcription or acoustic feature extraction.

The term “image information” refers to visual data, such as still images or video frames, captured by an imaging device and including facial regions, body posture, or environmental scenes that can be processed to derive user-related features.

The term “behavior information” refers to data describing current or recent user actions or movements, derived from sensor readings, interaction logs, or context detection, and used for recognizing patterns of user conduct.

The term “life-related information” refers to information associated with daily activities and circumstances of a user, including schedules, locations, physical activity levels, rest patterns, and contextual details relevant to the user's lifestyle.

The term “feature value” refers to a numerical or categorical representation derived from raw data, such as sensor readings or logs, that is structured for input into a machine learning model for inference or classification.

The term “machine learning model” refers to a computational model trained on data to learn patterns or relationships and configured to perform tasks such as classification, regression, clustering, or prediction when provided with feature values.

The term “situation of the user” refers to a generalized state or context characterizing the user's current circumstances, such as working, resting, commuting, shopping, or sleeping, inferred from multiple data sources.

The term “preference information” refers to data indicating likes, dislikes, and tendencies of a user regarding content, activities, products, or services, derived from explicit user input or implicit behavioral signals.

The term “prompt sentence” refers to a natural-language or structured instruction that encodes contextual information and directives and that is provided as input to a generative AI model to guide the model's output.

The term “generative AI model” refers to a machine learning model configured to generate data, such as text, audio, or other structured or unstructured outputs, in response to input prompts or context information.

The term “proposal” refers to a suggested course of action, content selection, or informational recommendation generated by computation for the purpose of influencing or supporting user behavior, decision making, or quality of life.

The term “quality of life” refers to a general measure of well-being of a user, including aspects such as comfort, stress level, satisfaction, and productivity, as can be indirectly influenced through personalized proposals and content.

The term “proposal content” refers to the specific information, instructions, or descriptions produced by computation or a generative AI model that constitute a recommendation or suggestion to the user.

The term “external information provision service” refers to a remote system or service accessible via a communication network that provides content, data, or functions, such as media delivery, product catalogs, or informational resources.

The term “information retrieval identifier” refers to a reference token, code, or parameter used to locate or retrieve specific information or content from an external information provision service.

The term “media information” refers to data representing digital media resources, such as audio tracks, playlists, video items, images, or other consumable content units.

The term “merchandise information” refers to data describing goods or services available for acquisition or use, including attributes such as category, function, price, and availability.

The term “action instruction information” refers to data specifying operational steps, control commands, or behavioral suggestions to be carried out by a device or by the user.

The term “acoustic output device” refers to hardware configured to produce sound, such as a speaker, earphone, or other audio transducer.

The term “display device” refers to hardware configured to present visual information to a user, such as a monitor, mobile device screen, or head-mounted display.

The term “environment control device” refers to hardware configured to modify a physical environment, including but not limited to lighting devices, climate control devices, or devices that emit scents or other environmental stimuli.

The term “response information” refers to data indicating a user's reaction to presented proposal content, including explicit responses such as selections, acceptances, rejections, or ratings, and implicit responses such as continued usage or disengagement.

The term “change in the emotional state” refers to a variation over time in an estimated emotional state of a user, measured by comparing emotional state estimates before and after presentation of proposal content.

The term “preference model” refers to a computational representation of user preferences, constructed and updated from observed data, that can be used to predict user choices or to personalize proposals.

The term “history data” refers to accumulated records of past inferences, emotional states, prompt sentences, model outputs, user responses, and related contextual information stored for analysis or retraining.

The term “emotion estimation unit” refers to a functional component, implemented in hardware, software, or a combination thereof, that processes multimodal input data to estimate an emotional state of a user.

The term “estimation accuracy” refers to the degree of correspondence between an inferred or predicted value, such as a situation or emotional state, and a true or target value, as evaluated by an error measure or performance metric.

The term “suitability of the proposal content” refers to how well the proposal content matches user needs, preferences, and current context, as assessed by indicators such as user acceptance, engagement, or improvement in quality of life.

In one embodiment, a server cooperates with one or more terminals operated by a user to implement a system that generates personalized proposals using a generative AI model guided by context-dependent prompt sentences. The server comprises at least one processor, a memory, a communication interface, and non-transitory storage that stores program instructions and data structures. The terminal comprises a processor, sensors, a display device and/or acoustic output device, an optional environment control device interface, and a communication module.

The server executes a program that is structured as multiple cooperating software modules, including a data acquisition module, a feature extraction module, a situation inference module, an emotion estimation module, a preference modeling module, a prompt generation module, a generative inference interface module, a proposal mapping module, an action control module, and a learning module. The server may implement these modules in a general-purpose runtime environment such as a Python runtime, using software frameworks such as a numerical computation library, a matrix-processing library, a neural network framework, and an image-processing library.

The terminal executes a program that manages sensor access, user interface presentation, and device control. The terminal may be a smartphone, a tablet, a wearable device, a head-mounted display, or a combination thereof. The terminal includes detection devices such as a global positioning sensor, a motion sensor, a heart-rate sensor, a microphone, and a camera. The terminal also includes an application program that runs on an operating system to interact with the server over a network.

The server acquires user attribute information, such as long-term interests and preferred media types, and user activity information, such as past application usage and movement statistics, from the terminal. The server stores this information in a structured data repository. In one embodiment, the server uses a relational database management system to maintain tables for users, sensor readings, context snapshots, model outputs, and feedback events. Each context snapshot is represented as a record containing a user identifier, a timestamp, aggregated activity features, a situation label, an emotion label, and a set of proposal identifiers previously presented to the user.

The server uses a feature extraction module implemented with a numerical processing library to process raw sensor data and log data into feature vectors. The server defines a fixed-length feature vector structure composed of multiple fields, including:
temporal fields (e.g., encoded hour of day and day of week),
spatial fields (e.g., discretized location regions),
physiological fields (e.g., normalized heart rate and heart rate variability),
application usage fields (e.g., usage duration of categories of applications),
recent activity segments (e.g., cumulative steps in recent time windows),
summary statistics of user responses to proposals (e.g., acceptance ratios by category).

The server encodes categorical variables using one-hot or embedding-based representations and normalizes numerical variables using precomputed mean and variance. By enforcing this specific data structure, the server improves the stability and speed of downstream neural network inference, because the model receives a consistent and compact representation that reduces unnecessary branching and preprocessing at inference time.

The server implements a situation inference module using a neural network model constructed, for example, as a multi-layer feedforward network. In one embodiment, the server defines a network with:
an input layer corresponding to the feature vector dimension,
several fully connected hidden layers with nonlinear activation functions,
a final softmax output layer that produces a probability distribution over a discrete set of user situations, such as working, resting, commuting, shopping in a store, or sleeping.

The server trains this model offline using labeled historical data. The server uses a loss function such as cross-entropy between predicted and true situation labels, and updates model parameters using a gradient-based optimization algorithm such as stochastic gradient descent with momentum or an adaptive learning-rate method. The server may use data augmentation techniques, such as adding noise to sensor features or slightly perturbing timestamps, to increase robustness against measurement errors. Through this design, the server achieves improved situation classification accuracy and improved robustness to noisy sensor input compared to conventional rule-based classifiers.

The server also implements an emotion estimation module that processes multimodal inputs. The server uses an image-processing library to detect a face in image information acquired from the camera of the terminal. The server normalizes the face image by cropping, resizing, and adjusting color or brightness. The server then passes this normalized image to an emotion classification network, such as a convolutional neural network with multiple convolutional and pooling layers followed by fully connected layers. This network outputs probabilities for emotion categories such as happiness, relaxation, stress, sadness, and anger. The server uses a loss function such as cross-entropy during training to optimize this network.

The server processes voice information acquired from the microphone of the terminal. The server extracts acoustic features, such as pitch, energy, speaking rate, and spectral coefficients, from the raw waveform. The server may also input the waveform into an acoustic classifier, such as a recurrent or convolutional network, that outputs an emotion distribution. The server combines the acoustic emotion probabilities with the visual emotion probabilities using a fusion rule, such as a weighted average or a small fully connected network that takes both outputs as inputs. The server optionally analyzes transcribed speech text (for example, obtained through a speech recognition service) to detect emotion keywords. The server fuses these signals into a single emotional state label and a confidence score.

The server uses a preference modeling module that maintains a preference model for each user. The server represents each user's preference model as a vector of weights across content and proposal dimensions, such as media genres, activity categories, and product categories. The server updates this vector using an online learning rule each time proposal content is presented and user response information is received. For instance, when the user accepts a proposal of a certain category, the server increases the corresponding weight; when the user rejects a proposal, the server decreases that weight or adjusts related dimensions. This model enables the server to adaptively shape future proposals without requiring explicit ratings.

The server implements a prompt generation module that constructs prompt sentences for the generative AI model. The server uses a rule-based template system extended by learned weighting of context elements. The server stores multiple prompt templates for different scenarios, such as work-related focus improvement, rest and relaxation, in-store promotion, and meal suggestion. Each template includes labeled slots for situation description, emotional state, user preferences, and constraints, such as time limits or dietary requirements.

The server selects a template based on the inferred situation and preference model and then fills the slots with textual fragments derived from the current context snapshot. The server determines which context elements to include or emphasize using learned weights that are part of the preference model. For example, when the user historically responds better to music suggestions than to exercise suggestions, the server increases the weight of music-related descriptors in the prompt sentence. This procedure goes beyond manually fixed prompts and adapts the prompt structure in a way that is not obvious to human operators, thus improving the quality and consistency of generative AI outputs.

Examples of prompt sentences generated by the server include:
“The user is currently working at a desk and has been sitting for 2 hours without a break. The user's emotional state is slightly tired but not highly stressed. The user prefers instrumental music. Please propose a short break activity and one or more instrumental music playlists that will improve focus after the break.”
“The current situation of the user is a lunch break at the office. The user feels a bit tired and likes jazz and lo-fi hip-hop. Please recommend relaxing music playlists that help the user recharge during lunch and keep the total listening time within 30 minutes.”
“A customer is standing in front of the sneakers corner and looking at lightweight running shoes with interest. The customer looks relaxed and positive. Please generate attractive promotion text and key selling points for these running sneakers, focusing on daily walking and light jogging.”
“The user's schedule is very busy today, and the recognized emotion is stress. The user prefers Japanese-style food and light meals at night. Please propose a relaxing dinner menu or drink that helps reduce stress.”

The server sends such a prompt sentence, together with optional structured context metadata, to a generative AI model interface. The generative AI model may be a large-scale language generation model running on a separate inference engine. The server communicates with the generative model through an application programming interface. To improve calculation efficiency and reduce communication overhead, the server may compress context metadata, reuse model sessions across multiple prompts for the same user, and cache frequently used intermediate results.

The server implements a generative inference interface module that manages request and response data structures in memory. The server formats the prompt sentence and context in a standardized structure and sends a request to the generative AI model. The server receives the model's generated text, which includes narrative descriptions of recommended activities, media selections, or product features. The server may request the model to provide responses in a semi-structured textual format, such as clearly separated sections or markers, to ease downstream parsing. This structure reduces parsing errors compared to free-form responses, thereby improving the reliability and speed of mapping model outputs into machine-executable actions.

The server implements a proposal mapping module that transforms abstract generative outputs into concrete items and device commands. This module uses dictionaries mapping textual categories or descriptors to specific external service identifiers. For media proposals, the server uses keywords such as genre, mood, and duration to query a media catalog through an external content API. The server receives a set of item identifiers (e.g., playlist IDs or track IDs) and selects suitable items based on ranking criteria, such as popularity, length matching the requested duration, and diversity across previous proposals. For product-related proposals, the server uses descriptor matching between generated text and attributes stored in a merchandise database, selecting specific items and associated offer information.

The server then builds a proposal content object that contains human-readable text, selected item identifiers, and control directives for the terminal. This object is stored in a data structure that includes fields for display text, audio resource identifiers, environmental control parameters (e.g., strength and duration of scent emission), and trigger conditions for subsequent updates. Because the server explicitly defines this data structure and mapping process, the system can reliably transform complex generative outputs into deterministic, verifiable actions that can be executed by devices.

The terminal receives proposal content through a communication interface, such as a push notification channel or a persistent connection. The terminal parses the proposal content object and updates its user interface. In the case of media playback, the terminal uses a media playback software library or software development kit to control the acoustic output device. The terminal may call an external media streaming service library with the received playlist or item identifiers to start playback. For environmental control, the terminal sends control signals to an environment control device, such as an aroma diffuser or lighting system, over a local network or another communication interface, using vendor-provided control protocols.

The terminal displays the proposal content text on its display device or overlays product information in the field of view when the terminal is a head-mounted display. The terminal may show interactive controls allowing the user to accept, postpone, or reject the proposal. When the user provides an explicit response, the terminal sends response information to the server. When the user does not respond explicitly, the terminal still monitors implicit signals, such as whether media playback continues for a sufficient duration, and sends these signals as part of its behavior history information.

The server implements a learning module that uses response information and emotional state changes to improve internal models. The server associates each proposal with pre-and post-proposal emotional state estimates and the user response. The server updates the preference model values based on whether the proposal led to acceptance, sustained usage, or improved emotional indicators, such as reduced stress or increased relaxation. The server stores these associations as history data and periodically retrains the machine learning models and emotion estimation networks using this growing dataset. The retraining process uses loss functions such as prediction error for situations or differences between predicted and observed emotional outcomes. The server updates neural network weights by executing gradient-based updates across mini-batches of stored context snapshots. This retraining improves estimation accuracy and adaptation to the evolving user behavior.

Because the system uses multimodal signals, structured feature representations, and learned prompt generation logic, the server achieves technical improvements in several aspects. First, the server reduces communication load by pre-aggregating raw data into compact feature vectors before sending them to the situation inference and generative interface modules, instead of streaming raw sensor data or large unstructured logs. Second, the server reduces computation time in the generative AI model by generating concise but context-rich prompt sentences that encode only the most relevant features, as determined by the preference model and situation inference. This reduces the prompt length and associated processing latency. Third, the system improves the accuracy and stability of recommendations by closing the loop between emotion estimation, proposal outcome, and model updating, enabling the server to adjust both model parameters and prompt construction rules according to objective performance measures, such as acceptance rates and emotional improvement.

The described system differs from mere automation of human decision-making tasks in that the server implements specific data structures, feature extraction pipelines, and multistage neural network architectures that would be impractical to execute manually. The server applies non-trivial combinations of temporal aggregation, multimodal fusion, and adaptive template selection that exploit correlations in high-dimensional data not observable in traditional manual workflows. Furthermore, by mapping generative outputs to precise device control instructions, the server directly controls hardware entities, such as audio devices and environment control devices, in a manner that is optimized by data-driven learning rather than by static, hand-crafted rules.

In another embodiment, the server and terminal may be configured for in-store operation. In this embodiment, the terminal is a head-mounted display that includes an eye-tracking sensor and a wide-angle camera. The terminal captures gaze vectors and video frames and sends them to the server. The server uses a computer-vision model trained to detect product regions in the camera view and correlates gaze vectors with product regions to determine which items the user is viewing. The server then generates prompt sentences tailored to in-store promotion, such as the sneakers example described earlier, and obtains generative AI model outputs that are mapped to product identifiers in the store inventory. The terminal overlays promotion messages directly in the user's view. The same learning and feedback mechanisms apply, adjusting future prompts and product selections based on prior responses and changes in emotional state, thereby improving the efficiency of in-store user-device interaction.

In yet another embodiment, the server may emphasize health-related proposals. In this case, the feature vector includes more detailed physiological features, such as long-term trends in heart rate variability and sleep-wake cycles. The situation inference model may include additional output classes such as “pre-sleep relaxation” or “post-exercise recovery.” The generative AI model may receive prompt sentences focusing on recovery and rest, and the proposal mapping module may select combinations of music, lighting patterns, and aroma intensity that encourage relaxation. Again, user responses and emotional feedback are used to refine the health-oriented preference model.

Other variations are possible. The server may replace the fully connected situation classifier with a sequence model that processes time-series segments of feature vectors; the server may use different neural architectures for emotion estimation; the server may adjust training strategies, such as using different optimization algorithms or regularization techniques. The terminal may be any device capable of acquiring sensor data and presenting proposal content; the environment control device may be any device that influences the user's environment, such as climate control, illumination, or haptic output.

Through these embodiments, the server and terminal implement a concrete set of technical mechanisms—specific data structures, feature extraction algorithms, neural network architectures, prompt generation and parsing strategies, and device control mappings—that integrate generative AI models into a closed-loop, multimodal personalization system. This configuration improves the performance, reliability, and technical capabilities of the underlying computer system, providing advantages in speed, accuracy, and resource utilization beyond conventional, static recommendation pipelines.

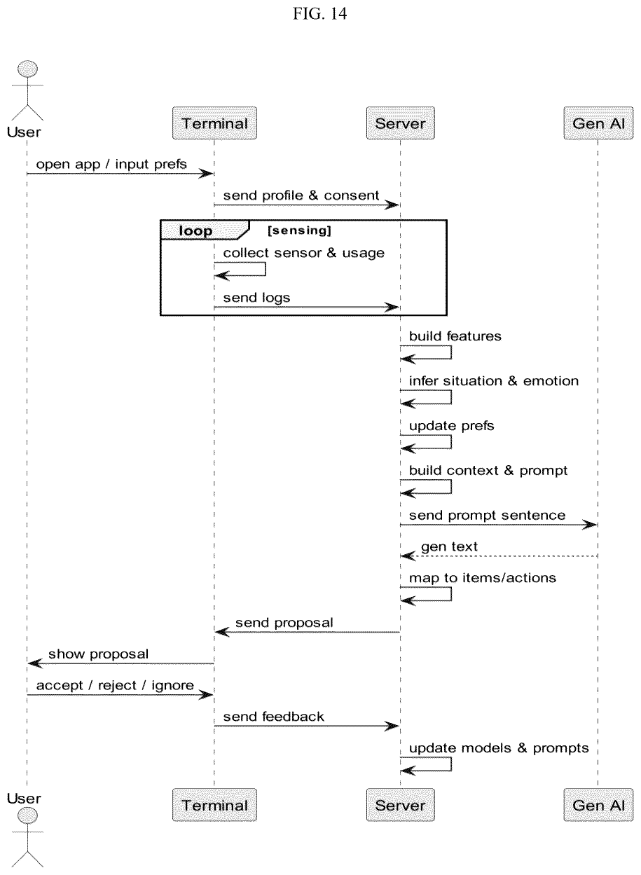

The following describes the processing flow using FIG. 14.

### Step 1

User operates a terminal to provide initial information and consents.

User launches an application on the terminal and inputs profile data, lifestyle preferences, and optional free-text comments (for example, “Tomorrow I have many meetings” or “I feel tired today”). User grants or denies permissions for sensors and external services (location, microphone, camera, notifications, media service account, environment control devices).

Input: user keystrokes, touch events, and OS-level permission responses.

Server receives, via the terminal, structured profile fields (age range, preferred media genres, food categories) and preference flags as a formatted data object. The program maps these inputs into normalized attribute fields and stores them in a user profile record.

Output: a stored and normalized user profile and permission configuration associated with a user identifier.

### Step 2

Terminal automatically collects sensor and usage data according to granted permissions.

Terminal periodically reads sensor values (position from a location sensor, motion from an accelerometer and gyroscope, heart rate from a physiological sensor), and logs application usage statistics (application identifiers, start/stop timestamps, screen-on time). Terminal optionally records short voice segments and captures face images when the user interacts with the app or a voice assistant.

Input: raw sensor streams and OS-level usage logs.

Terminal aggregates this raw data into time-stamped records (for example, one record per minute) and tags them with a device identifier and user identifier. Terminal compresses or batches these records and sends them to the server via a network interface.

Output: a batch of structured sensor and usage records transmitted to the server.

### Step 3

Server validates and stores incoming records.

Server receives batched records from the terminal, verifies authentication tokens, checks data schema, and rejects malformed entries. Server writes valid records into storage tables for sensor readings, usage logs, and interaction logs, and stores large binary payloads, such as images and audio clips, in an object storage service while keeping references in the tables.

Input: batched records containing sensor values, usage entries, and media references.

Server parses the records, extracts required fields, and normalizes time formats, then stores them in appropriate tables (for example, “sensor_log,” “usage_log,” “media_log”).

Output: persistent, indexed data rows ready for analysis, each linked to a user identifier and time interval.

### Step 4

Server constructs feature vectors from stored data.

Server retrieves recent logs (for example, last 60-120 minutes) for a user from storage. Server groups records by time window (for example, 5-minute or 10-minute windows) and computes aggregated measures, such as average heart rate, total steps, speed of movement, application usage duration by category, and number of prior proposals accepted in that period.

Input: time-ordered sensor and usage log records.

Server performs data cleaning (removing out-of-range values, filling missing entries with interpolated or default values) and then calculates statistical features (means, variances, counts) and categorical encodings (one-hot or embedding indices) for each attribute. Server concatenates all features into a fixed-length numerical vector that represents the user's current context.

Output: a feature vector ready for machine learning inference, associated with the current analysis time.

### Step 5

Server infers the user's situation using a machine learning model.

Server loads a pre-trained situation classification model and passes the feature vector to the model. The model performs a forward computation through its layers (for example, multiple dense layers with nonlinear activation functions) to generate a probability distribution over predefined situation classes such as working, resting, commuting, shopping in a store, or sleeping.

Input: the context feature vector from Step 4.

Server applies a softmax operation on the model's output logits to obtain situation probabilities, selects the class with the highest probability as the situation label, and records this label along with its probability.

Output: an inferred situation label and corresponding probability scores for each possible situation.

### Step 6

Server estimates the user's emotional state from image, audio, and behavior data.

Server retrieves recent face images and audio clips referenced in the logs. Server uses an image-processing library to detect face regions in the images, then crops and resizes each face to a standard resolution and normalizes color values. Server passes each normalized image through an emotion classification neural network (for example, a convolutional network) to obtain emotion probabilities.

Input: image references, audio references, and recent behavior features (for example, movement intensity, response to prior proposals).

Server extracts acoustic features from audio (such as pitch and energy over frames), optionally passes them through an acoustic classifier network, and obtains a second set of emotion probabilities. Server combines visual and acoustic probabilities, optionally weighted by confidence scores, and then adjusts the combined estimate using recent behavior features (for example, prolonged inactivity plus negative keywords).

Output: a unified emotional state label (such as relaxed, stressed, sad, or angry) and an associated confidence value.

### Step 7

Server updates and queries the user preference model.

Server reads the current preference model for the user (a vector of weights across proposal categories and content types) from storage. Server examines historical response data for prior proposals, including acceptance rates, times to acceptance, and changes in emotional state after different types of proposals.

Input: stored preference weights and feedback history records.

Server updates the weights using an online rule: for categories associated with accepted proposals or improved emotional states, server increases the corresponding weights; for categories associated with rejected proposals or no improvement, server decreases or dampens those weights.

Output: an updated preference model reflecting the user's evolving tendencies, stored back in the user's profile.

### Step 8

Server builds a context object used for prompt generation.

Server consolidates outputs from situation inference, emotion estimation, and preference modeling. Server forms a context object that includes: (a) the current situation label and probability distribution, (b) the current emotional state and confidence, (c) important features from the context vector (such as sitting duration, location category, and time of day), and (d) key elements of the preference model (such as top preferred content categories and disfavored categories).

Input: situation label and probabilities, emotional state, feature vector, and updated preference weights.

Server filters out less influential features based on internal rules (for example, ignoring rarely used content types) and orders remaining features by relevance to prompt construction (for example, prioritizing emotional state and top preferences).

Output: a compact context object describing the user's state and preferences in a machine-readable structure.

### Step 9

Server selects a prompt template and generates a prompt sentence.

Server examines the current situation (for example, working, lunch break, shopping, or preparing for sleep) and selects a scenario-specific template stored in a template library. Server then fills template slots using information from the context object: describing the situation in words, describing the emotional state, listing key preferences, and specifying constraints (for example, time limit for a break or dietary restriction).

Input: the context object with situation, emotion, and preference information.

Server generates a natural-language prompt sentence that summarizes this context and instructs the generative AI model to produce a particular type of output (such as a playlist recommendation, a relaxation routine, or product promotion text).

Output: a completed prompt sentence suitable for input to a generative AI model, for example:
“The user is currently working at a desk and has been sitting for 2 hours without a break. The user's emotional state is slightly tired but not highly stressed. The user prefers instrumental music. Please propose a short break activity and one or more instrumental music playlists that will improve focus after the break.”

### Step 10

Server sends the prompt sentence to the generative AI model and obtains generated content.

Server creates a request object that includes the prompt sentence and optional parameters such as output length and stylistic constraints. Server transmits this request to the generative AI model via an interface. The model processes the prompt and returns generated text describing recommended actions, media selections, or products.

Input: the prompt sentence and any generation parameters.

Server receives the generative output, which may contain structured segments (for example, sections for activity description, music description, and rationale). Server parses the output into internally labeled segments and extracts essential details such as recommended activity type, media moods and genres, time durations, and product features.

Output: parsed generative output segments containing abstract proposals and descriptive text.

### Step 11

Server maps abstract proposals to concrete external resources and device actions.

Server analyzes each proposal segment and identifies key attributes (for example, “relaxing jazz playlist for 30 minutes,” “lightweight running sneakers for daily walking”). Server queries external content and product APIs using these attributes. For media suggestions, server sends search queries with genre, mood, and duration filters and receives specific item identifiers. For product suggestions, server matches textual features to items in a product database, using text similarity or attribute matching.

Input: parsed generative description segments and external service catalogs or product databases.

Server ranks returned items according to internal criteria (such as compatibility with user preferences and novelty relative to recent presentations) and selects a manageable subset. Server then constructs a proposal content object that includes textual summary, selected item identifiers, and device control parameters (for example, whether to start playback automatically or only after user confirmation).

Output: a machine-readable proposal content object linking generative descriptions to specific content and control directives.

### Step 12

Server sends proposal content to the terminal and logs the event.

Server packages the proposal content into a message that includes identifiers for targeted terminal devices and user identifiers. Server uses a communication channel, such as push messaging or a network API, to send the message. Server also records the proposal event in a log that includes time, content category, selected items, and the context snapshot used to generate it.

Input: the final proposal content object and addressing information for the terminal.

Server updates statistics related to resource usage and classification, facilitating later performance evaluation and model retraining.

Output: proposal content delivered to the terminal and a stored record of the proposal event.

### Step 13

Terminal presents the proposal to the user and waits for interaction.

Terminal receives the proposal content from the server, parses the object, and prepares user interface elements. Terminal displays a notification or screen with descriptive text, buttons for actions (for example, “Play now,” “Later,” or “No thanks”), and any relevant images or icons. Terminal may also prepare commands to control an audio output device or environment control device but only execute them after user confirmation if so specified.

Input: the proposal content object from the server.

Terminal schedules UI updates and may adjust layout depending on device type (for example, full-screen for a smartphone, overlay for a head-mounted display).

Output: visual and/or audio presentation of the proposal to the user, and pending action handlers awaiting user input.

### Step 14

User responds to the proposal explicitly or implicitly.

User taps a button, uses a gesture, or issues a voice command to accept, postpone, or reject the proposal. Alternatively, user may ignore the proposal, or user may passively consume suggested content (for example, allow a playlist to continue playing) without explicit confirmation.

Input: the displayed proposal interface and any active device controls (media player, environment control).

Terminal records the user's explicit response or the lack thereof, as well as implicit signals such as playback duration or whether an associated device action was kept active.

Output: response information or interaction events that characterize how the user reacted to the proposal.

### Step 15

Terminal sends response information and subsequent sensor/emotion data to the server.

Terminal packages the user's explicit response, implicit behavior signals, and follow-up sensor data (for example, updated heart rate, movement indicators, and any new face images or audio segments) into log entries. Terminal transmits these entries back to the server.

Input: response events from Step 14 and new sensor readings and media logs.

Terminal ensures these logs are tagged with the proposal identifier so that the server can correlate responses with specific proposals.

Output: a batch of feedback logs delivered to the server, linking user reactions and subsequent state to the proposal event.

### Step 16

Server updates internal models and prompt strategy based on feedback.

Server receives feedback logs and associates them with prior proposal events and context snapshots. Server compares emotional state estimates before and after the proposal, calculates changes in emotional indicators, and correlates these changes with acceptance, rejection, or passive consumption.

Input: feedback logs containing user responses, follow-up sensor data, and any updated emotional state estimations.

Server updates the preference model weights for each proposal category and content type, adjusts internal counters of effective and ineffective proposals, and stores these results in history data. Server may also mark certain prompt template patterns as more or less effective for the user and adjust future prompt construction rules accordingly. Over time, server uses accumulated history to retrain or fine-tune the situation inference and emotion estimation models, thereby lowering classification error and improving the alignment of generated proposals with desired outcomes.

Output: refined preference models, updated prompt generation tendencies, and, when retraining is performed, improved model parameters for situation and emotion inference.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

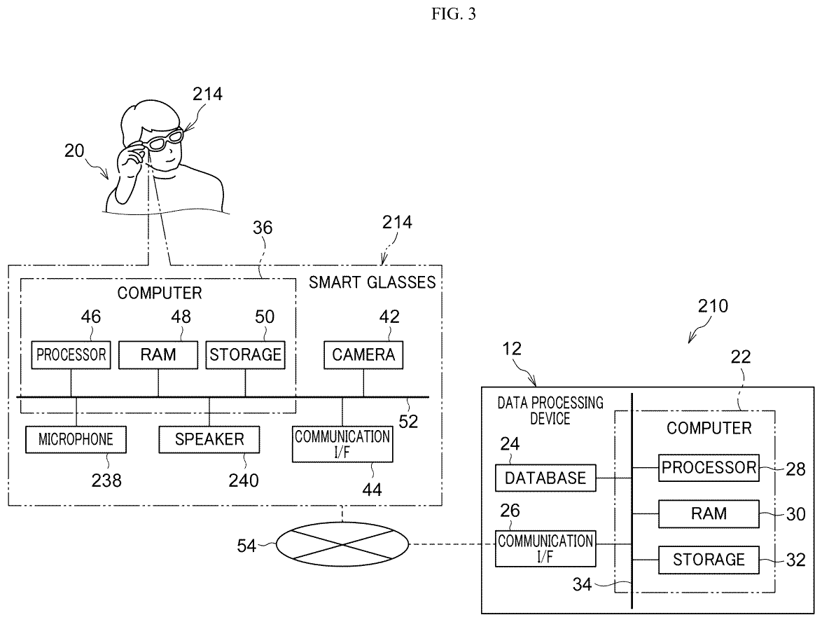

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

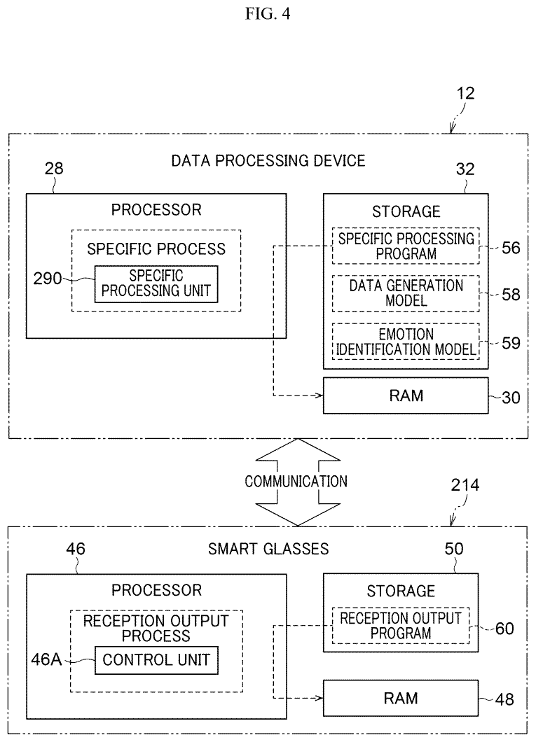

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

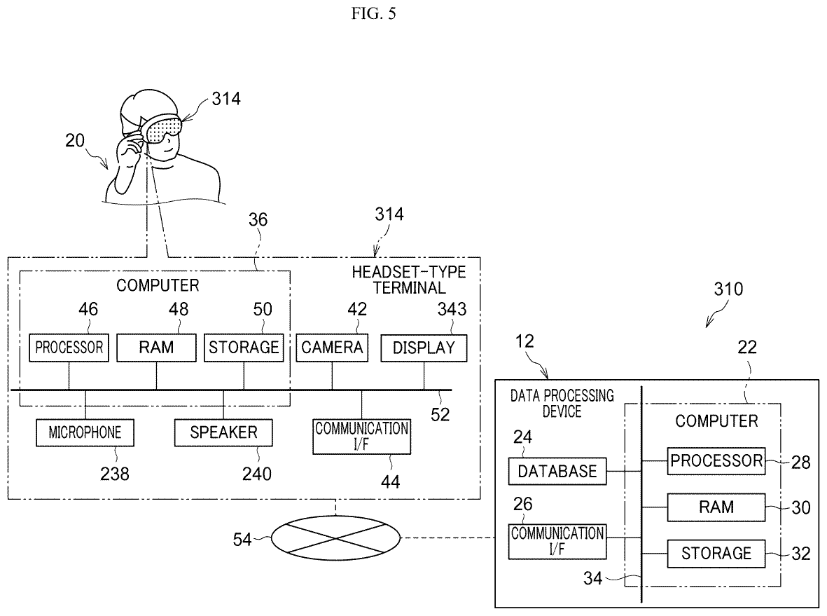

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

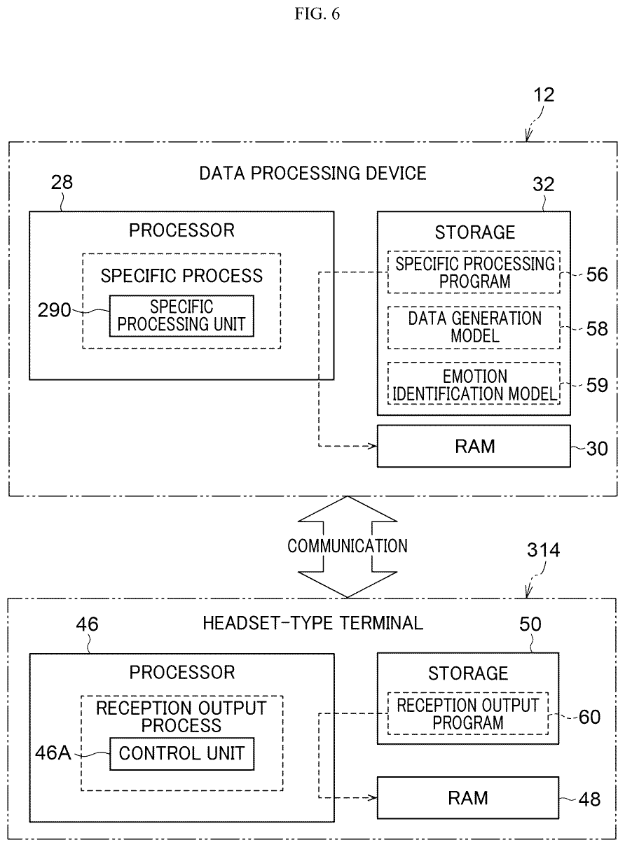

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc.

The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

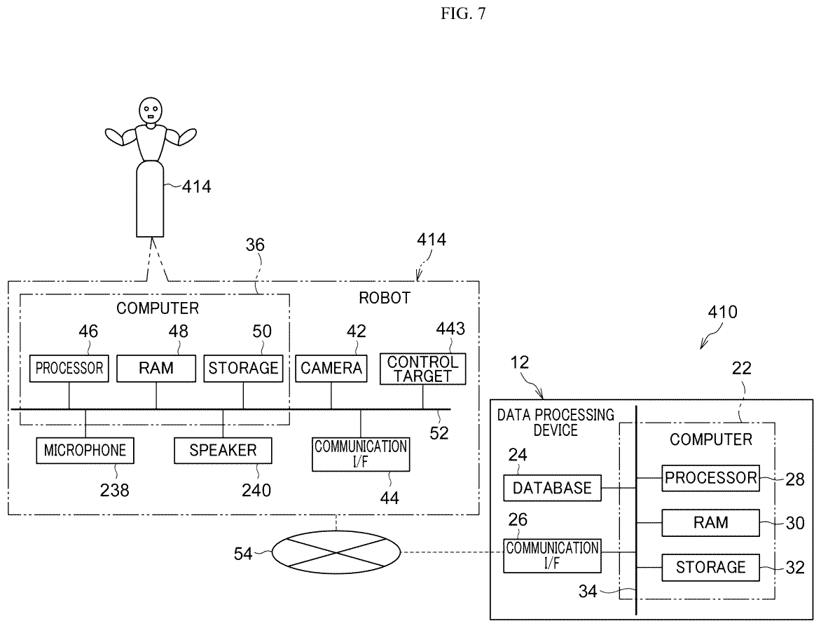

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

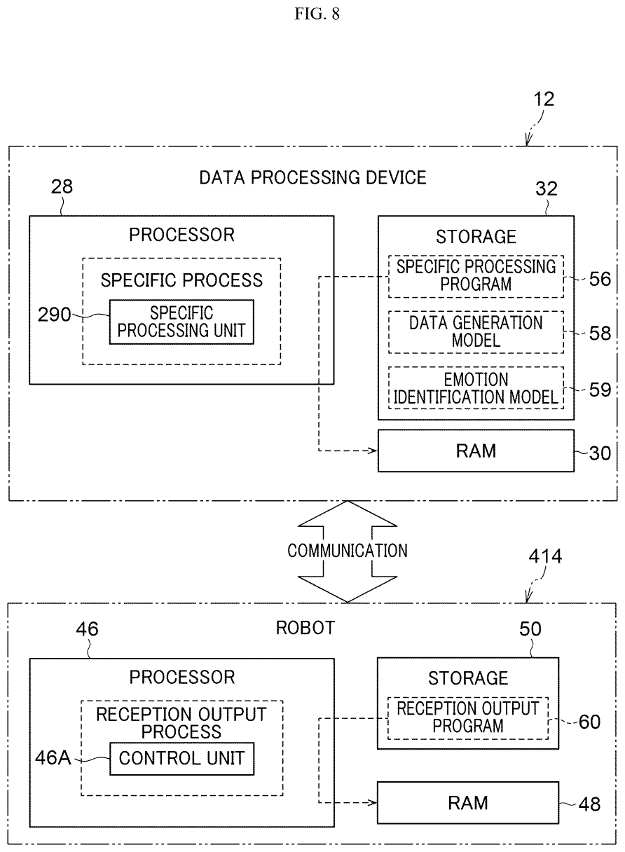

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

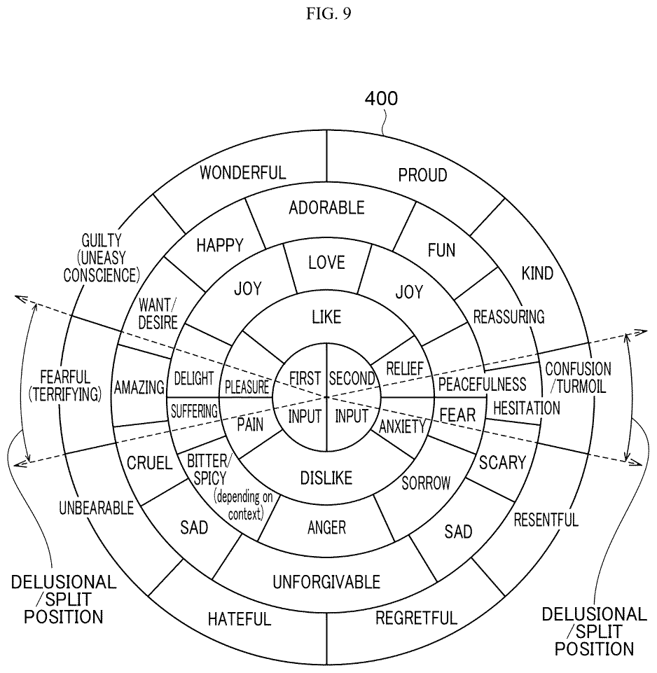

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

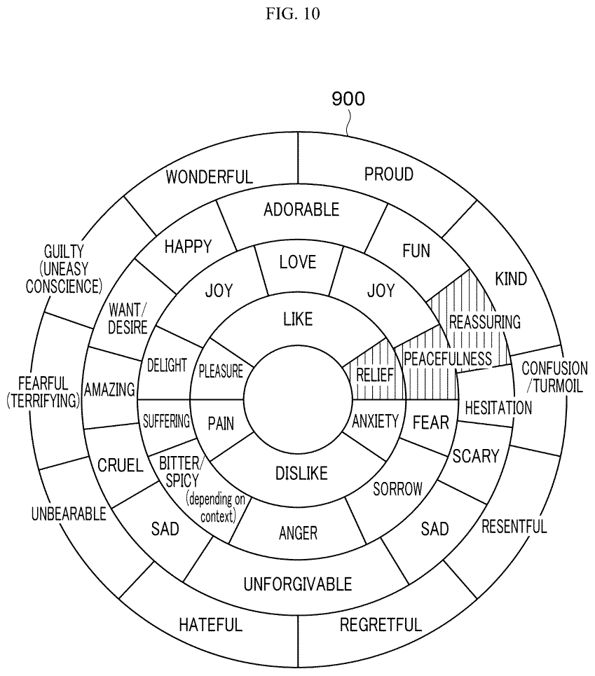

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
generate a user interface on an information input-output apparatus, the user interface being configured to receive life information including schedule information, preference information, and behavior information from a user,
acquire environmental information including location information, electronic communication records, and browsing history from a user apparatus by using a position detection device, an information acquisition control unit, and a communication unit provided in the user apparatus, and collect the environmental information in association with the life information,
integrate and store the life information and the environmental information in a storage unit,
perform preprocessing including normalization of time information, aggregation of location information, and classification of behavior types, and thereby generate integrated data representing a behavior history of the user,
calculate, on the basis of the integrated data, behavior frequencies for each date category, time zone, and place category, repeated behaviors, and preference tendencies, and generate behavior feature information summarizing the behavior frequencies, the repeated behaviors, and the preference tendencies,
construct, on the basis of the behavior feature information and future available time slot information, a description sentence in a natural language including an operation instruction for a generative AI model, and generate the description sentence as a prompt sentence for the generative AI model,
generate an electronic communication request for inputting the prompt sentence and the integrated data to the generative AI model, transmit the electronic communication request to the generative AI model, and receive a response sentence from the generative AI model,
extract contents of activity plans from the response sentence, compare the contents of the activity plans with the schedule information of the user to detect a temporal contradiction or a constraint violation, and generate a life improvement plan adapted to a behavior pattern of the user by accepting or correcting the activity plans on the basis of a detection result, and
notify the life improvement plan to the information input-output apparatus, acquire acceptance information or rejection information for the life improvement plan from the information input-output apparatus, and update the behavior feature information and contents of generation of the prompt sentence on the basis of the acceptance information or the rejection information.

### Supplementary 2

The system according to supplementary 1,
wherein the processor is configured to
analyze the response sentence obtained from the generative AI model to extract an activity type, a recommended time zone, and a recommended reason, calculate a suitability degree for each activity plan on the basis of an appearance frequency of each activity type in the behavior feature information and past acceptance information or rejection information, and present a customized life improvement plan for each user by controlling a display order or selection candidates of the activity plans according to the suitability degree.

### Supplementary 3

The system according to supplementary 1,
wherein the processor is configured to
generate feature quantities indicating behavior frequencies for each time zone category, stay tendencies for each place category, and preference degrees for each behavior type when storing the life information and the environmental information in the storage unit, construct a clean data set including the feature quantities for input to the generative AI model, and dynamically change summary contents and a description order of the behavior feature information included in the prompt sentence by using an update history of the feature quantities.

### Application Example 1

### Supplementary 1

A system comprising a processor,
wherein the processor is configured to
acquire user lifestyle-related information including schedule information, preference information, and behavior information via an input/output device that receives operations from a user,
automatically collect measurement information, activity history information, and electronic record information from an information acquisition device including a position detection device, a motion detection device, and application software, and store the collected information in association with the user lifestyle-related information,
convert the stored lifestyle-related information into a table-type data structure and generate a learning data set for input to a generative AI model by performing preprocessing including missing-value completion processing and outlier-removal processing using numerical calculation processing,
generate context information describing a situation and interest of the user based on the lifestyle-related information, and construct a prompt sentence including the context information and generation instruction conditions as an input sentence to the generative AI model,
cause the generative AI model, by using the prompt sentence, to estimate behavior and interest of the user, and obtain estimation information representing the situation and interest of the user from an output of the generative AI model,
construct, based on the estimation information, an additional prompt sentence for generating proposal information relating to lifestyle improvement, and generate a plurality of concrete proposal pieces of information by using the generative AI model,
acquire candidate information including advertisement information or content information from an external information providing device, and select and rank the candidate information based on a degree of relevance to the estimation information and the proposal information, and
integrate the proposal information and selected external information, generate display-structured information, transmit the display-structured information to a terminal device, and cause the terminal device to present the proposal information and the external information on a user interface.

### Supplementary 2

The system according to supplementary 1,
wherein the processor is configured to
acquire operation history relating to the proposal information or the external information on the terminal device as behavior history information, add the behavior history information as the lifestyle-related information to the learning data set, and continuously update the prompt sentence input to the generative AI model and contents of the proposal information so as to dynamically optimize contents of lifestyle-improvement proposals and presentation control according to a behavior pattern of the user.

### Supplementary 3

The system according to supplementary 1,
wherein the processor is configured to
assign validity-period information and priority information to each of the proposal information and the external information based on time information and position information included in the estimation information, and control a presentation order and a presentation mode on the terminal device according to the validity-period information and the priority information so as to present information in real time in accordance with a current situation of the user.

### Example 2

### Supplementary 1

A system comprising a processor,
wherein the processor is configured to
acquire, from a terminal, time-series user activity information and location information automatically obtained by a positioning device and a motion detection device of the terminal, and
receive the time-series information via a communication network,
read the received time-series information from a storage device and perform preprocessing including missing-value completion processing, outlier removal processing, and feature normalization processing to generate an input data set for machine learning,
input the input data set into a machine learning algorithm and obtain a situation estimation result indicating a current situation or behavioral state of a user,
generate a prompt sentence to be input to a generative artificial intelligence model, the prompt sentence being generated on the basis of at least part of the situation estimation result and at least one of time information, location information, and activity trend information,
instruct the generative artificial intelligence model to generate recommendation information by using the prompt sentence, and obtain a natural-language recommendation sentence from the generative artificial intelligence model as a generation result, and
transmit the recommendation sentence as notification data to the terminal and cause the terminal to present the notification data on a display unit of the terminal.

### Supplementary 2

The system according to supplementary 1,
wherein the processor is configured to
obtain operation information of the user from the terminal after the recommendation sentence is presented, store the operation information in association with the situation estimation result and the prompt sentence, and update at least one of the machine learning algorithm and a generation method of the prompt sentence on the basis of the operation information.

### Supplementary 3

### The System According to Supplementary 1,

wherein the processor is configured to
extract context information including at least a user behavior pattern, a time period, and a location category on the basis of the situation estimation result, and describe the context information in a structured manner within the prompt sentence so that the generative artificial intelligence model outputs a user-specific lifestyle improvement recommendation.

### Application Example 2

### Supplementary 1

A system comprising a processor,
wherein the processor is configured to
acquire user attribute information and user activity information,
automatically collect position information, biological information, usage history information, and behavior history information of a user from a user terminal device via detection devices and application programs installed in the user terminal device,
estimate an emotional state of the user on the basis of voice information, image information, and behavior information of the user,
generate feature values from collected life-related information and the estimated emotional state, and input the feature values to a machine learning model to infer a situation of the user,
generate a prompt sentence, based on the situation of the user, the emotional state of the user, and preference information of the user, for causing a generative AI model to infer behavior of the user and to generate a proposal for improving quality of life of the user, and input information to the generative AI model by using the prompt sentence,
analyze proposal content output from the generative AI model and, by associating the proposal content with an information retrieval identifier of an external information provision service,
select concrete media information, merchandise information, or action instruction information,
notify the selected information to the user terminal device and control the user terminal device to operate at least one of an acoustic output device, a display device, or an environment control device so as to present the proposal content to the user, and
acquire response information of the user to the proposal content and a change in the emotional state of the user after presentation of the proposal content, and update generation of the prompt sentence and a content of the proposal content on the basis of the response information and the change in the emotional state.

### Supplementary 2

The system according to supplementary 1,
wherein the processor is configured to
store, in association with one another, attribute information of the media information, attribute information of the merchandise information, or attribute information of the action instruction information included in the proposal content output from the generative AI model, behavior history information of the user, response information of the user, and a change history of the emotional state of the user, update a preference model for each user on the basis of the association, and dynamically change a structure of the prompt sentence and a type of the proposal content on the basis of the updated preference model.

### Supplementary 3

### The System According to Supplementary 1,

wherein the processor is configured to
accumulate, as history data, the inference result of the situation of the user, the emotional state of the user, the prompt sentence, the output of the generative AI model, and the response information of the user, and retrain parameters of the machine learning model and an emotion estimation unit on the basis of the history data so as to improve estimation accuracy of the situation of the user and suitability of the proposal content.

What is claimed is:

1. A system comprising:
circuitry configured to
receive, via a packet-switched network, first data records from a terminal device, each first data record comprising user-input attribute data;
acquire, via the packet-switched network, second data records from sensor interfaces and application interfaces of the terminal device, each second data record comprising automatically collected contextual data including geolocation coordinate data and temporal stamp data;
integrate the first data records and the second data records into a storage device and apply a preprocessing operation comprising temporal normalization, geolocation aggregation, and categorical classification to generate integrated feature data representing a historical pattern of the contextual data;
compute, based on the integrated feature data, behavior frequency values for each of a plurality of temporal category partitions and a plurality of geolocation category partitions, and generate behavior feature information data summarizing the behavior frequency values and repeated pattern indicators;
generate a structured input sequence for a generative neural network model based on the behavior feature information data and available time slot data, the structured input sequence comprising a natural language instruction portion specifying a generation task;
input the structured input sequence to the generative neural network model to obtain output character sequence data;
parse the output character sequence data to extract a plurality of proposed action data items, each proposed action data item comprising an action type identifier, a recommended temporal window, and a justification character sequence;
compare each proposed action data item with schedule constraint data stored in the storage device to detect a temporal conflict or a constraint violation, and
generate a validated plan data set by accepting, rejecting, or modifying each proposed action data item based on a detection result; and
transmit, via the packet-switched network, the validated plan data set to the terminal device for rendering on a display of the terminal device.

2. The system according to claim 1, wherein the preprocessing operation further comprises removing non-conforming data entries from the second data records based on a value range validation rule, and normalizing temporal stamp data to a unified time zone reference.

3. The system according to claim 2, wherein the categorical classification comprises mapping each second data record to a behavior type category selected from a predefined set of behavior type categories based on feature values extracted from the contextual data.

4. The system according to claim 3, wherein the first data records comprise schedule information representing planned activities and time allocations, preference information representing user-specified interests and priorities, and routine information representing habitual daily patterns of the user, and wherein the second data records comprise location tracking data from a position detection sensor, communication log data from a messaging application, and content access history data from a browsing application.

5. The system according to claim 4, wherein the behavior feature information data further comprises preference tendency indicators derived from the content access history data, and wherein the behavior frequency values include exercise frequency, commute frequency, and leisure activity frequency computed per temporal category partition.

6. The system according to claim 1, wherein the generative neural network model comprises a transformer-based language model having an embedding layer that maps input token identifiers to multidimensional vector representations, a plurality of self-attention layers that compute attention weight distributions over the vector representations, and a feed-forward output layer that generates a probability distribution over a vocabulary of token identifiers.

7. The system according to claim 6, wherein the structured input sequence further encodes a constraint specification portion that defines a predetermined output format for the output character sequence data, the predetermined output format comprising labeled fields for an action type identifier, a temporal window specification, and a justification text segment.

8. The system according to claim 7, wherein parsing the output character sequence data comprises detecting labeled field delimiters within the output character sequence data, segmenting the output character sequence data into a plurality of action data sections based on the detected delimiters, and extracting the action type identifier, the recommended temporal window, and the justification character sequence from each action data section.

9. The system according to claim 8, wherein each proposed action data item further comprises a recommended location category and an estimated duration value, and wherein the justification character sequence references specific behavior frequency values and repeated pattern indicators from the behavior feature information data.

10. The system according to claim 1, wherein the circuitry is further configured to:
compare the recommended temporal window of each proposed action data item with existing schedule entries stored in the storage device by computing a temporal overlap value; and
when the temporal overlap value exceeds a threshold, modify the recommended temporal window to a next available time slot determined from the schedule constraint data.

11. The system according to claim 10, wherein the circuitry is further configured to apply a priority ranking to the plurality of proposed action data items based on a relevance score computed from the behavior feature information data, and resolve temporal conflicts by preserving higher-priority proposed action data items and rescheduling lower-priority proposed action data items.

12. The system according to claim 11, wherein the validated plan data set comprises a life improvement plan including a sequence of recommended activities, associated temporal windows, and personalized justification text derived from the behavior feature information data of the user.

13. The system according to claim 1, wherein the circuitry is further configured to:
receive, via the packet-switched network, acceptance data or rejection data from the terminal device for each proposed action data item in the validated plan data set; and
update the behavior feature information data and generation parameters of the structured input sequence based on the acceptance data or rejection data, the updating comprising adjusting a summary content and a description order of the behavior feature information data encoded in subsequent structured input sequences.

14. The system according to claim 13, wherein the circuitry is further configured to store, in the storage device, a history of acceptance data and rejection data associated with proposed action data items over a plurality of temporal periods, and compute updated feature weight values based on the history to bias future generation of the structured input sequence toward action types having higher historical acceptance rates.

15. The system according to claim 1, wherein the circuitry is further configured to apply an affective state estimation model to at least one of the first data records and the second data records to determine an affective state indicator, and include the affective state indicator in the structured input sequence to enable the generative neural network model to generate proposed action data items that account for the affective state.

16. The system according to claim 15, wherein the affective state estimation model comprises a neural network classifier that receives a numerical feature vector derived from the contextual data and outputs a probability distribution over a plurality of affective category labels.

17. The system according to claim 16, wherein the circuitry is further configured to adjust a presentation style parameter of the validated plan data set transmitted to the terminal device based on the affective state indicator, including selecting a notification tone and a text emphasis level corresponding to the dominant affective category label.

18. A system comprising:
circuitry configured to
receive, via a packet-switched network, user-input attribute data and automatically collected contextual data comprising geolocation coordinate data and temporal stamp data from a terminal device;
integrate the user-input attribute data and the contextual data into a storage device, apply a preprocessing operation comprising temporal normalization, geolocation aggregation, value range validation, and categorical classification to generate integrated feature data;
compute behavior frequency values for a plurality of temporal category partitions and geolocation category partitions, and generate behavior feature information data comprising the behavior frequency values, repeated pattern indicators, and preference tendency indicators;
apply an affective state estimation model to the contextual data to determine an affective state indicator;
generate a structured input sequence for a generative neural network model encoding the behavior feature information data, available time slot data, and the affective state indicator, the structured input sequence comprising a natural language instruction portion and a constraint specification portion defining a predetermined output format;
input the structured input sequence to the generative neural network model to obtain output character sequence data, and parse the output character sequence data to extract a plurality of proposed action data items each comprising an action type identifier, a recommended temporal window, and a justification character sequence;
compare each proposed action data item with schedule constraint data to detect temporal conflicts and generate a validated plan data set by accepting, modifying, or rejecting each proposed action data item; and
transmit, via the packet-switched network, the validated plan data set to the terminal device for rendering on a display of the terminal device.

19. The system according to claim 18, wherein the circuitry is further configured to receive acceptance data or rejection data from the terminal device for the validated plan data set, and update the behavior feature information data and generation parameters of the structured input sequence based on a cumulative history of acceptance and rejection data to improve alignment of future proposed action data items with user preferences.

20. A method comprising:
receiving, via a packet-switched network, first data records from a terminal device, each first data record comprising user-input attribute data;
acquiring, via the packet-switched network, second data records from sensor interfaces and application interfaces of the terminal device, each second data record comprising automatically collected contextual data including geolocation coordinate data and temporal stamp data;
integrating the first data records and the second data records into a storage device and applying a preprocessing operation comprising temporal normalization, geolocation aggregation, and categorical classification to generate integrated feature data representing a historical pattern of the contextual data;
computing, based on the integrated feature data, behavior frequency values for each of a plurality of temporal category partitions and a plurality of geolocation category partitions, and generating behavior feature information data summarizing the behavior frequency values and repeated pattern indicators;
generating a structured input sequence for a generative neural network model based on the behavior feature information data and available time slot data, the structured input sequence comprising a natural language instruction portion specifying a generation task;
inputting the structured input sequence to the generative neural network model to obtain output character sequence data;
parsing the output character sequence data to extract a plurality of proposed action data items, each proposed action data item comprising an action type identifier, a recommended temporal window, and a justification character sequence;
comparing each proposed action data item with schedule constraint data stored in the storage device to detect a temporal conflict or a constraint violation, and generating a validated plan data set by accepting, rejecting, or modifying each proposed action data item based on a detection result; and
transmitting, via the packet-switched network, the validated plan data set to a terminal device for rendering on a display of the terminal device.
